(19) United States
(12) Patent Application Publication
(10) Pub. No.: US 2026/0046823 A1
(43) Pub. Date: Feb. 12, 2026

(54) LOW-LATENCY NON-TERRESTRIAL NETWORK-BASED USER EQUIPMENT LOCATION VERIFICATION

(71) Applicant: Lenovo (Singapore) Pte. Ltd., Singapore (SG)

(72) Inventors: Sher Ali Cheema, Ilmenau (DE); Robin Rajan Thomas, Bad Nauheim (DE); Dimitrios Karampatsis, Ruislip (GB); Majid Ghanbarinejad, Chicago, IL (US); Vijay Nangia, Woodridge, IL (US); Konstantinos Samdanis, Munich (DE)

(21) Appl. No.: 19/102,812

(22) PCT Filed: Sep. 15, 2022
(86) PCT No.: PCT/EP2022/075660

§ 371 Date: Feb. 10, 2025

(30) Foreign Application Priority Data
Aug. 10, 2022 (GR) 20220100670

(51) Int. Cl. H04W 64/00; H04W 4/029

(52) U.S. Cl. CPC H04W 64/00; H04W 4/029

(57) ABSTRACT

Various aspects of the present disclosure relate to techniques for low-latency non-terrestrial network (NTN)-based user equipment (UE) location verification. An apparatus is configured to transmit a UE location request comprising a location configuration to a second network entity with location server functionality, the location configuration comprising a type of method to be used for location determination and an indication that location estimates for the UE are for verification, receive a location information response from the second network entity based on the UE location request, wherein the location information response comprises location estimates for the UE, and perform a verification process of the location estimates for the UE based on the received location information response.

### FIELD

The subject matter disclosed herein relates generally to wireless communications and more particularly relates to low-latency non-terrestrial network (“NTN”)-based user equipment (“UE”) location verification.

### BACKGROUND

In wireless networks, UE positioning may refer to technology that is used in the wireless network to determine the geographic location, position, and/or velocity of a UE. Due to the large coverage areas exhibited by NTN cells, conventional terrestrial network positioning verification mechanisms may not be applicable to NTN systems.

### BRIEF SUMMARY

Disclosed are solutions for low-latency NTN-based UE location verification. The solutions may be implemented by apparatus, systems, methods, or computer program products.

In one embodiment, a first apparatus includes a transceiver and a processor coupled to the transceiver. In one embodiment, the processor is configured to cause the apparatus to transmit a low-latency UE location request comprising a location configuration to a second network entity with location server functionality, the location configuration comprising at least a request to provide location information for the UE within a configured time window, receive a location information response from the second network entity based on the transmitted location request, and perform a low-latency verification process of the location information for the UE based on the received location response.

In one embodiment, a first method transmits a low-latency UE location request comprising a location configuration to a second network entity with location server functionality, the location configuration comprising at least a request to provide location information for the UE within a configured time window, receives a location information response from the second network entity based on the transmitted location request, and performs a low-latency verification process of the location information for the UE based on the received location response.

In one embodiment, a second apparatus includes a transceiver and a processor coupled to the transceiver. In one embodiment, the processor is configured to cause the apparatus to receive a low-latency UE location verification request comprising a location configuration from a second network entity, the location configuration comprising at least a request to provide location information for the UE within a configured time window, perform a low-latency verification process of the location information for the UE, and transmit a location information response to the second network entity based on the transmitted verification request.

In one embodiment, a second method receives a low-latency UE location verification request comprising a location configuration from a second network entity, the location configuration comprising at least a request to provide location information for the UE within a configured time window, performs a low-latency verification process of the location information for the UE, and transmits a location information response to the second network entity based on the transmitted verification request

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for low-latency NTN-based UE location verification;

FIG. 2 is a block diagram illustrating one embodiment of a 5G NR protocol stack;

FIG. 3 depicts one embodiment of NR Beam-based Positioning;

FIG. 4A depicts one embodiment of downlink time difference of arrival (“DL-TDOA”) Assistance Data;

FIG. 4B depicts one embodiment of DL-TDOA Measurement Report;

FIG. 5 depicts one embodiment of the overall architecture for UE positioning applicable to new generation radio access network (“NG-RAN”);

FIG. 6 depicts one embodiment of location service support by NG-RAN;

FIG. 7 depicts one embodiment of an NG-RAN location reporting procedure;

FIG. 8a depicts one embodiment of a networking-RAN architecture with transparent satellite;

FIG. 8b depicts one embodiment of a regenerative satellite without inter-satellite links (“ISLs”) and a gNB processed payload;

FIG. 8c depicts one embodiment of a regenerative satellite with ISLs and a gNB processed payload;

FIG. 9A depicts one embodiment of a procedure for low latency verification procedure using NG-RAN and location management component (“LMC”) combined functionality;

FIG. 9B depicts one embodiment of another procedure for low latency verification procedure using NG-RAN and LMC combined functionality;

FIG. 10a depicts one embodiment of a procedure for a network induced location request with a specific method type;

FIG. 10b depicts one embodiment of a procedure for a network induced multiple location requests with multiple method types;

FIG. 11a depicts one embodiment of a verification procedure based on multiple location estimates;

FIG. 11b depicts one embodiment of a simplified verification procedure based on multiple location estimates;

FIG. 11c depicts one embodiment of a location estimation and verification procedure using RAT-dependent methods;

FIG. 12 depicts one embodiment of an LMF-based location estimation and verification procedure;

FIG. 13 is a block diagram illustrating one embodiment of a user equipment apparatus that may be used for low-latency NTN-based UE location verification;

FIG. 14 is a block diagram illustrating one embodiment of a network apparatus that may be used for low-latency NTN-based UE location verification;

FIG. 15 is a flowchart diagram illustrating one embodiment of a method for low-latency NTN-based UE location verification; and

FIG. 16 is a flowchart diagram illustrating one embodiment of another method for low-latency NTN-based UE location verification.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for low-latency NTN-based UE location verification. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

There are no conventional methods that exist that enable the verification of a UE's reported location in an NTN network deployment. Due to the large coverage areas exhibited by NTN cells, the current terrestrial network mechanism requires certain enhancements. Furthermore, the conclusions of TR 38.882 have identified the need to define a network-based solution that aims at verifying the reported UE location information. Depending on the configured positioning method, the network verification procedures would need to be enhanced to provide accurate, reliable, and low-latency verified UE locations considering the satellite movement, wider range, higher Doppler shift, and/or the like. The present disclosure provides a set of procedural enhancements to enable support of RAT-dependent (e.g., network-based) network verification procedures over an NTN network.

Additionally, there are no known mechanisms to verify the accuracy and reliability of a UE's location based on NTN RAT-dependent positioning methods since all methods have been designed with terrestrial networks in mind. According to Solution #18 of TR 23.700-030, the location verification is performed using the network data analytics function (“NWDAF”) network entity, which enables the access and mobility management function (“AMF”) to receive statistics and predictions on the UE location, hence making it easier to determine whether the potentially inaccurate location information provided by the UE is reliable and trustable or not. This solution mainly does not consider the location management function (“LMF”) in the network verification procedure of the UE and has high signaling overhead. According to Solution #24 of TR 23.700-030, NG-RAN assistance information is used to verify the UE's location, however this solution does not consider the details of this NG-RAN assistance information and how the AMF can trigger the LMF to initiate NTN RAT-dependent location verification procedures.

The subject matter herein provides support for a low-latency network verified UE location procedure considering the additional propagation delays due to NTN gNB and UE signaling after registration. In this disclosure, methods/configurations are disclosed for having a low latency UE verification procedure. The verification process may either be carried out by an AMF, LMF, or LMC, depending on the applicable scenario. In one embodiment, the LMF may be co-located with the NG-RAN node, where such implementation may be more common in NTN networks to avoid long propagation delays, therefore enhancing the location accuracy. This implies that the gateway and NTN-gNB could be equipped with LMC functionality or be co-located with the LMF, making a verification process at the LMC have a very low latency. Moreover, the verification process needs only to be carried out by reliable location estimation procedure, e.g., a RAT-dependent method. Therefore, procedures are disclosed to employ RAT-dependent methods for verification. In addition, procedures are disclosed to show that RAT independent methods may be used for emergency and regulatory services, if these can be considered as reliable.

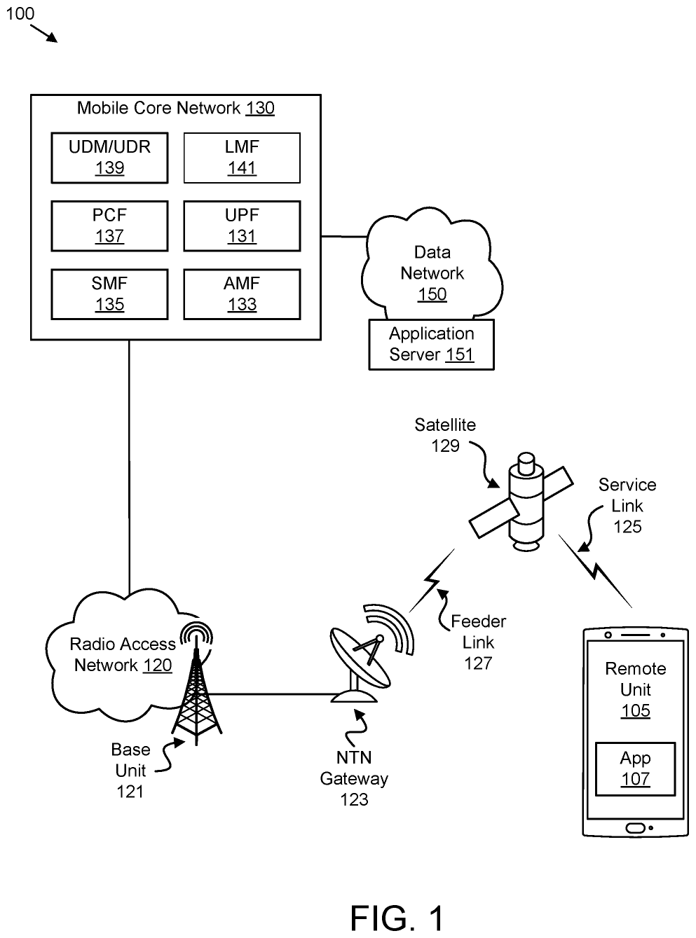

FIG. 1 depicts a wireless communication system 100 for low-latency NTN-based UE location verification, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates via a satellite 129 using wireless communication links, e.g., service link(s) 125 and feeder link(s) 127. As depicted, the mobile communication network includes an “on-ground” base unit 121 and non-terrestrial network (“NTN”) gateway 123 which serves the remote unit 105 via satellite access.

Even though a specific number of remote units 105, base units 121, wireless communication links, RANs 120, satellites 129, NTN gateways 123 (e.g., satellite ground/earth devices), and mobile core networks 140 are depicted in FIG. 1, one of skill in the art will recognize that any number of remote units 105, base units 121, wireless communication links, RANs 120, satellites 129, NTN gateways 123, and mobile core networks 140 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. In some embodiments, the remote units 105 communicate in a non-terrestrial network via UL and DL communication signals between the remote unit 105 and a satellite 129. In certain embodiments, the satellite 129 may communicate with the RAN 120 via an NTN gateway 123 using UL and DL communication signals between the satellite 129 and the NTN gateway 123. The NTN gateway 123 may communicate directly with the base units 121 in the RAN 120 to relay UL and DL communication signals.

Furthermore, the UL and DL communication signals may be carried over the wireless communication links during at least a portion of their path between RAN 120 and the remote unit 105. In the depicted embodiment, the wireless communication link between the remote unit 105 and satellite 129 comprises a service link 125, while the wireless communication link between the satellite 129 and the base unit 121 comprises a feeder link 127. However, in other embodiments, the satellite(s) and NTN gateways may be deployed between the base unit 121 or RAN 120 and the mobile core network 140, e.g., similar to wireless backhaul links.

The RAN 120 is an intermediate network that provides the remote units 105 with access to the mobile core network 140. In various embodiments, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”).

Moreover, the satellite 129 provides a non-terrestrial network allowing the remote unit 105 to access the mobile core network 140 via satellite access. While FIG. 1 depicts a transparent NTN system where the satellite 129 repeats the waveform signal for the base unit 121, in other embodiments the satellite 129 (for regenerative NTN system), or the NTN gateway 123 (for alternative implementation of transparent NTN system) may also act as base station, depending on the deployed configuration.

In some embodiments, the remote units 105 communicate with an application server via a network connection with the mobile core network 130. For example, an application 107 (e.g., web browser, media client, telephone and/or Voice-over-Internet-Protocol (“VOIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

To establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120. Note that in the NTN scenario, certain RAN entities or functions may be incorporated into the satellite 129. For example, the satellite 129 may be an embodiment of a Non-Terrestrial base station/base unit.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Location Management Function (“LMF”) 141, a Unified Data Management function (“UDM”) and a User Data Repository (“UDR”) 139.

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The LMF 141, in one embodiment, receives positioning measurements or estimates from RAN 120 and the remote unit 105 (e.g., via the AMF 133) and computes the position of the remote unit 105. The UDM 139 is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

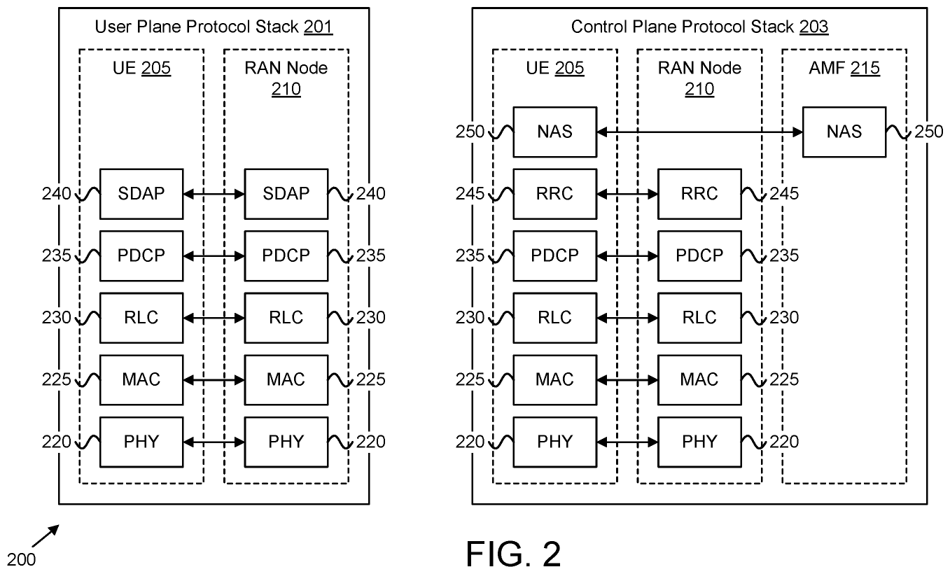

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and a Service Data Adaptation Protocol (“SDAP”) sublayer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) sublayer 245 and a Non-Access Stratum (“NAS”) sublayer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (e.g., RAN node 210) and carries information over the wireless portion of the network.

As background, NR positioning based on NR Uu signals and standalone (“SA”) architecture (e.g., beam-based transmissions) was first specified in Rel-16. The target use cases also included commercial and regulatory (e.g., emergency services) scenarios as in Rel-15. The performance requirements are the following, e.g., described in TR 38.855:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

3GPP Rel-17 Positioning has recently defined the positioning performance requirements for Commercial and IIoT use cases as follows, e.g., as described in TR 38.857:

| Positioning Error | Commercial | IIoT |
|---|---|---|
| Horizontal Positioning | (<1 m) for 90% | (<0.2 m) for 90% of UEs; |
| | of UEs | |
| Vertical Positioning | (<3 m) for 90% | (<1 m) for 90% of UEs |
| | of UEs | |
| Physical layer latency for | (<10 ms) | (<10 ms) |
| position estimation of UE | | |
| End-to-End Latency for | (<100 ms) | (<100 ms, in the order of 10 |
| position estimation of UE | | ms is desired) |

Some UE positioning techniques supported in Rel-16 are listed in Table 1. The separate positioning techniques as indicated in Table 2 may be configured and performed based on the requirements of the LMF and/or UE capabilities. Note that Table 1 includes Terrestrial Beacon System (“TBS”) positioning based on PRS signals, but only observed time difference of arrival (“OTDOA”) based on LTE signals is supported. The E-CID includes Cell-ID for NR method. The TBS method refers to TBS positioning based on Metropolitan Beacon System (“MBS”) signals.

TABLE 1
Supported Rel-16 UE positioning methods

| | | | NG-RAN | Secure User |
|---|---|---|---|---|
| | | UE-assisted, | node | Plane Location |
| Method | UE-based | LMF-based | assisted | (“SUPL”) |
| A-GNSS | Yes | Yes | No | Yes |
| | | | | (UE-based and |
| | | | | UE-assisted) |
| OTDOA | No | Yes | No | Yes |
| | | | | (UE-assisted) |
| E-CID | No | Yes | Yes | Yes |
| | | | | for E-UTRA |
| | | | | (UE-assisted) |
| Sensor | Yes | Yes | No | No |
| WLAN | Yes | Yes | No | Yes |
| Bluetooth | No | Yes | No | No |
| TBS | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

The transmission of PRS enable the UE to perform UE positioning-related measurements to enable the computation of a UE's location estimate and are configured per Transmission Reception Point (“TRP”), where a TRP may transmit one or more beams.

In one embodiment, the following RAT-dependent positioning techniques may be supported by the system 100:

DL-TDoA: The downlink time difference of arrival (“DL-TDOA”) positioning method makes use of the DL RS Time Difference (“RSTD”) (and optionally DL PRS RS Received Power (“RSRP”) of DL PRS RS Received Quality (“RSRQ”)) of downlink signals received from multiple TPs, at the UE (e.g., remote unit 105). The UE measures the DL RSTD (and optionally DL PRS RSRP) of the received signals using assistance data received from the positioning server, and the resulting measurements are used along with other configuration information to locate the UE in relation to the neighboring Transmission Points (“TPs”).

DL-AoD: The DL Angle of Departure (“AoD”) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multi-RTT: The Multiple-Round Trip Time (“Multi-RTT”) positioning method makes use of the UE Receive-Transmit (“Rx-Tx”) measurements and DL PRS RSRP of downlink signals received from multiple TRPs, measured by the UE and the gNB Rx-Tx measurements (e.g., measured by RAN node) and UL sounding reference signal (“SRS”)-RSRP at multiple TRPs of uplink signals transmitted from UE.

The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the Round Trip Time (“RTT”) at the positioning server which are used to estimate the location of the UE. In one embodiment, Multi-RTT is only supported for UE-assisted/NG-RAN assisted positioning techniques, as noted in Table 1.

E-CID/NR E-CID: Enhanced Cell ID (“CID”) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (“NR E-CID”) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

UL-TDoA: The UL TDOA positioning method makes use of the UL TDOA (and optionally UL SRS-RSRP) at multiple reception points (“RPs”) of uplink signals transmitted from the UE. The RPs measure the UL TDOA (and optionally UL SRS-RSRP) of the received signals using assistance data received from the positioning server, and the resulting measurements are used along with other configuration information to estimate the location of the UE.

UL-AoA: The UL Angle of Arrival (“AoA”) positioning method makes use of the measured azimuth and the zenith angles of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

In one embodiment, the system 100 may support various RAT-Independent techniques, e.g., as described in TS 38.305. In one embodiment, network-assisted global navigation satellite system (“GNSS”) methods make use of UEs that are equipped with radio receivers capable of receiving GNSS signals. In 3GPP specifications the term GNSS encompasses both global and regional/augmentation navigation satellite systems.

Examples of global navigation satellite systems include GPS, Modernized GPS, Galileo, GLONASS, and BeiDou Navigation Satellite System (“BDS”). Regional navigation satellite systems include Quasi Zenith Satellite System (“QZSS”) while the many augmentation systems, are classified under the generic term of Space Based Augmentation Systems (“SBAS”) and provide regional augmentation services. In this concept, different GNSSs (e.g. GPS, Galileo, etc.) can be used separately or in combination to determine the location of a UE.

In one embodiment, a barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method may be combined with other positioning methods to determine the 3D position of the UE.

In one embodiment, a WLAN positioning method makes use of the WLAN measurements (e.g., AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server, to determine its location.

In one embodiment, a Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

In one embodiment, a TBS consists of a network of ground-based transmitters, broadcasting signals only for positioning purposes. The current type of TBS positioning signals are the MBS signals and PRS. The UE measures received TBS signals, optionally aided by assistance data, to calculate its location or to send measurements to the positioning server for position calculation.

In one embodiment, a motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

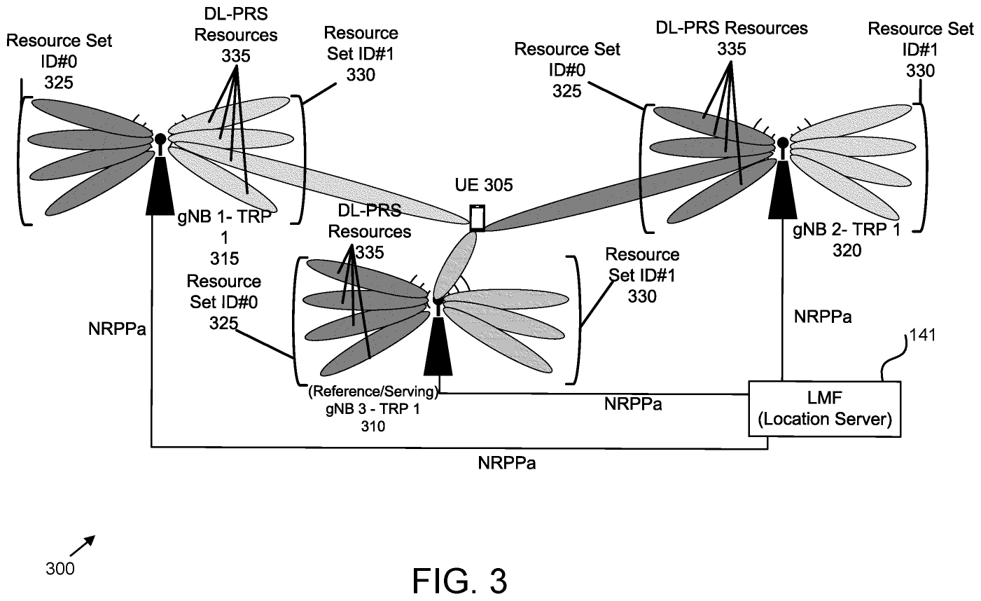

FIG. 3 depicts a system 300 for NR beam-based positioning. According to Rel-16, the PRS can be transmitted by different base stations (serving and neighboring) using narrow beams over Frequency Range #1 Between (“FR1”, e.g., frequencies from 410 MHz to 7125 MHz) and Frequency Range #2 (“FR2”, e.g., frequencies from 24.25 GHz to 52.6 GHz), which is relatively different when compared to LTE where the PRS was transmitted across the whole cell.

As illustrated in FIG. 3, a UE 305 may receive PRS from a first gNB (“gNB 3”) 310, which is a serving gNB, and also from a neighboring second gNB (“gNB 1”) 315, and a neighboring third gNB (“gNB 2”) 320. Here, the PRS can be locally associated with a set of PRS Resources grouped under a Resource Set ID for a base station (e.g., TRP). In the depicted embodiments, each gNB 310, 315, 320 is configured with a first Resource Set ID 325 and a second Resource Set ID 330. As depicted, the UE 305 receives PRS on transmission beams; here, receiving PRS from the gNB 3 310 on a set of PRS Resources 335 from the second Resource Set ID 330, receiving PRS from the gNB 1 315 on a set of PRS Resources 335 from the second Resource Set ID 330, and receiving PRS from the gNB 2 320 on a set of PRS Resources 335 from the first Resource Set ID 325.

Similarly, UE positioning measurements such as Reference Signal Time Difference (“RSTD”) and PRS RSRP measurements are made between beams as opposed to different cells as was the case in LTE. In addition, there are additional UL positioning methods for the network to exploit in order to compute the target UE's location. Table 2 and Table 3 show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, IMU sensor, WLAN and Bluetooth technologies for performing target device (e.g., UE) positioning.

TABLE 2
UE Measurements to enable RAT-dependent positioning techniques

| DL/UL Reference | | To facilitate support of the |
|---|---|---|
| Signals | UE Measurements | following positioning techniques |
| Rel. 16 DL PRS | DL RSTD | DL-TDOA |
| Rel. 16 DL PRS | DL PRS RSRP | DL-TDOA, DL-AoD, Multi-RTT |
| Rel. 16 DL PRS/ | UE Rx − Tx time difference | Multi-RTT |
| Rel. 16 SRS for | | |
| positioning | | |
| Rel. 15 SSB/CSI- | SS-RSRP(RSRP for RRM), SS- | E-CID |
| RS for RRM | RSRQ(for RRM), CSI-RSRP (for | |
| | RRM), CSI-RSRQ (for RRM), SS- | |
| | RSRPB (for RRM) | |

TABLE 3
gNB Measurements to enable RAT-dependent positioning techniques

| | gNB | To facilitate support of the |
|---|---|---|
| DL/UL Reference Signals | Measurements | following positioning techniques |
| Rel. 16 SRS for positioning | UL RTOA | UL-TDOA |
| Rel. 16 SRS for positioning | UL SRS-RSRP | UL-TDOA, UL-AoA, Multi-RTT |
| Rel. 16 SRS for positioning, | gNB Rx − Tx time | Multi-RTT |
| Rel. 16 DL PRS | difference | |
| Rel. 16 SRS for positioning, | AoA and ZoA | UL-AoA, Multi-RTT |

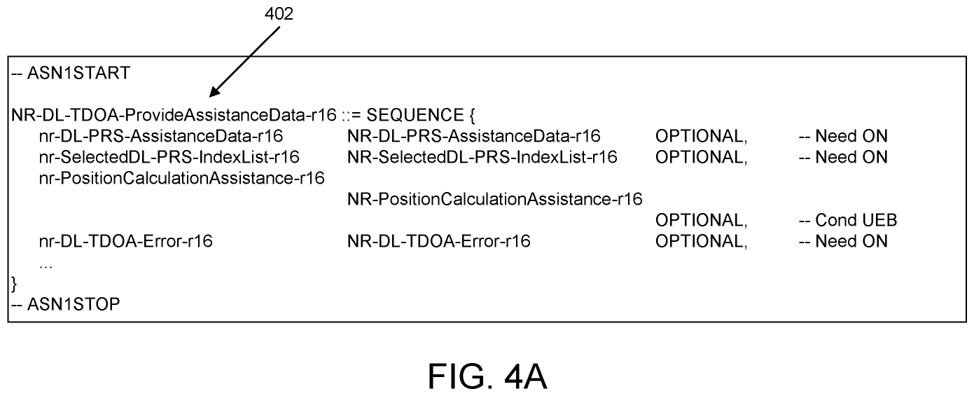

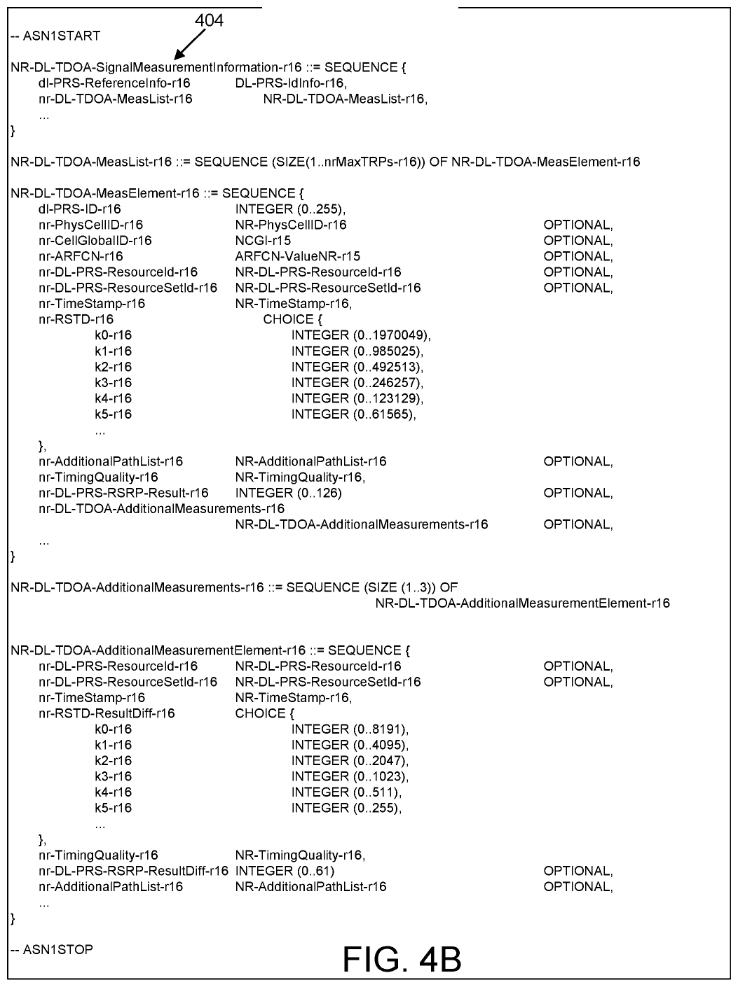

Regarding Measurement and Report Configuration, according to TS38.215, UE measurements have been defined, which are applicable to DL-based positioning techniques, see subclause 2.4. For a conceptual overview of the current implementation in Rel-16, the assistance data configurations (see FIG. 4A) and measurement information (see FIG. 4B) are provided for each of the supported positioning techniques:

The information element (“IE”) NR-DL-TDOA-Provide Assistance Data 402, shown in FIG. 4A, is used by the location server to provide assistance data to enable UE-assisted and UE-based NR downlink TDOA. It may also be used to provide NR DL TDOA positioning specific error reason.

The IE NR-DL-TDOA-SignalMeasurementInformation 404, shown in FIG. 4B, is used by the target device to provide NR-DL TDOA measurements to the location server. The measurements are provided as a list of TRPs, where the first TRP in the list is used as reference TRP in case RSTD measurements are reported. The first TRP in the list may or may not be the reference TRP indicated in the NR-DL-PRS-AssistanceData. Furthermore, the target device selects a reference resource per TRP, and compiles the measurements per TRP based on the selected reference resource.

Regarding RAT-dependent Positioning Measurements, the different DL measurements including DL PRS-RSRP, DL RSTD and UE Rx-Tx Time Difference required for the supported RAT-dependent positioning techniques are shown in Table 4. The following measurement configurations may be specified:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 4
DL Measurements required for DL-based positioning methods
DL PRS reference signal received power (DL PRS-RSRP)

| | |
|---|---|
| Definition | DL PRS reference signal received power (DL PRS-RSRP), is defined as the linear average over |
| | the power contributions (in [W]) of the resource elements that carry DL PRS reference signals |
| | configured for RSRP measurements within the considered measurement frequency bandwidth. |
| | For frequency range 1, the reference point for the DL PRS-RSRP shall be the antenna connector |
| | of the UE. For frequency range 2, DL PRS-RSRP shall be measured based on the combined |
| | signal from antenna elements corresponding to a given receiver branch. For frequency range 1 |
| | and 2, if receiver diversity is in use by the UE, the reported DL PRS-RSRP value shall not be |
| | lower than the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing difference between |
| | the positioning node j and the reference positioning node i, defined as T_{SubframeRxj} − T_{SubframeRxi}, |
| | Where: |
| | T_{SubframeRxj} is the time when the UE receives the start of one subframe from positioning node j. |
| | T_{SubframeRxi} is the time when the UE receives the corresponding start of one subframe from |
| | positioning node i that is closest in time to the subframe received from positioning node j. |
| | Multiple DL PRS resources can be used to determine the start of one subframe from a |
| | positioning node. |
| | For frequency range 1, the reference point for the DL RSTD shall be the antenna connector of |
| | the UE. For frequency range 2, the reference point for the DL RSTD shall be the antenna of the |
| | UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning node, defined by |
| | the first detected path in time. |
| | T_{UE-TX} is the UE transmit timing of uplink subframe #j that is closest in time to the subframe #i |
| | received from the positioning node. |
| | Multiple DL PRS resources can be used to determine the start of one subframe of the first |
| | arrival path of the positioning node. |
| | For frequency range 1, the reference point for T_{UE-RX} measurement shall be the Rx antenna |
| | connector of the UE and the reference point for T_{UE-TX} measurement shall be the Tx antenna |
| | connector of the UE. For frequency range 2, the reference point for T_{UE-RX} measurement shall be |
| | the Rx antenna of the UE and the reference point for T_{UE-TX} measurement shall be the Tx |
| | antenna of the UE. |
| Applicable for | RRC_CONNECTED intra-frequency |
| | RRC_CONNECTED inter-frequency |

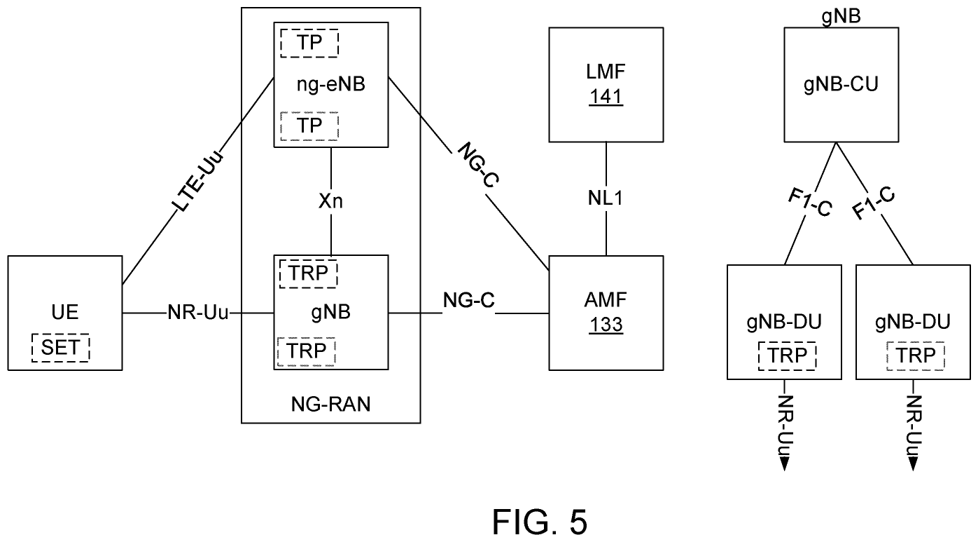

FIG. 5 shows the architecture in 5GS applicable to positioning of a UE with NR or E-UTRA access. In one embodiment, the AMF 133 receives a request for some location service associated with a particular target UE from another entity (e.g., Gateway Mobile Location Center (“GMLC”) or UE) or the AMF 133 itself decides to initiate some location service on behalf of a particular target UE (e.g., for an IP Multimedia System (“IMS”) emergency call from the UE), e.g., as described in TS 23.502 and TS 23.273. The AMF 133 then sends a location services request to an LMF 141. The LMF 141 processes the location services request which may include transferring assistance data to the target UE to assist with UE-based and/or UE-assisted positioning and/or may include positioning of the target UE. The LMF 141 then returns the result of the location service back to the AMF 133 (e.g., a position estimate for the UE). In the case of a location service requested by an entity other than the AMF 133 (e.g., a GMLC or UE), the AMF 133 returns the location service result to this entity.

In one embodiment, an NG-RAN node may control several TRPs/TPs, such as remote radio heads, or DL-PRS-only TPs for support of PRS-based TBS. In one embodiment, an LMF 141 may have a proprietary signaling connection to an E-Serving Mobile Location Center (“SMLC”) which may enable an LMF 141 to access information from E-UTRAN (e.g., to support the OTDOA for E-UTRA positioning method using downlink measurements obtained by a target UE of signals from eNBs and/or PRS-only TPs in E-UTRAN). An LMF 141 may have a proprietary signaling connection to an SLP. The SLP is the SUPL entity responsible for positioning over the user plane. Further details of user-plane positioning are provided in TS38.305 Annex A.

In case of split gNB architecture, a gNB-DU may include TRP functionality where the TRP functionality may support functions for a TP, RP or both TP and RP. A gNB-DU which includes TRP functionality does not need to offer cell services.

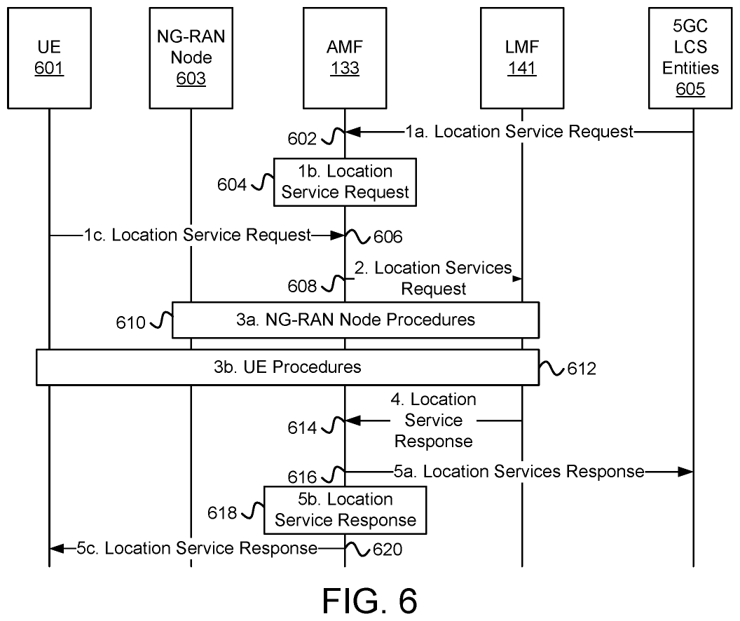

Regarding RAN-UE positioning operations, to support positioning of a target UE and delivery of location assistance data to a UE with NG-RAN access in 5GS, location related functions are distributed as shown in the architecture in FIG. 5 and as clarified in greater detail in TS 23.501 and TS 23.273. The overall sequence of events applicable to the UE, NG-RAN and LMF for any location service is shown in FIG. 6.

Note that when the AMF receives a Location Service Request in case the UE is in CM-IDLE state, the AMF performs a network triggered service request, e.g., as defined in TS 23.502 and TS 23.273, to establish a signaling connection with the UE and assign a specific serving gNB or NG-eNB. The UE is assumed to be in connected mode before the beginning of the flow shown in the FIG. 6; that is, any signaling that might be required to bring the UE to connected mode prior to step 1a is not shown. The signaling connection may, however, be later released (e.g., by the NG-RAN node as a result of signaling and data inactivity) while positioning is still ongoing.

The procedure flow depicted in FIG. 6, in one embodiment, includes a UE 601, an NG-RAN Node 603, an AMF 133, an LMF 141, and 5GC location services (“LCS”) Entities 605.

At step 1a, an entity in the 5GC (e.g., GMLC) requests (see messaging 602) a location service (e.g., positioning) for a target UE 601 to the serving AMF 133. At step 1b, the serving AMF 133 for a target UE 601 determines (see block 604) the need for some location service (e.g., to locate the UE 601 for an emergency call). At step 1c, the UE 601 requests (see messaging 606) some location service (e.g., positioning or delivery of assistance data) to the serving AMF 133 at the NAS level.

In one embodiment, at step 2, the AMF 133 transfers (see messaging 608) the location service request to an LMF 141. At step 3a, the LMF 141 instigates (see block 610) location procedures with the serving and possibly neighboring ng-eNB or gNB in the NG-RAN 603—e.g., to obtain positioning measurements or assistance data. In one embodiment, in addition to step 3a or instead of step 3a, at step 3b, the LMF 141 instigates (see block 612) location procedures with the UE 601—e.g., to obtain a location estimate or positioning measurements or to transfer location assistance data to the UE 601.

In one embodiment, at step 4, the LMF 141 provides (see messaging 614) a location service response to the AMF 133 and includes any needed results—e.g., success or failure indication and, if requested and obtained, a location estimate for the UE 601. In one embodiment, at step 5a, if step 1a was performed, the AMF 133 returns (see messaging 616) a location service response to the 5GC entity 605 in step 1a and includes any needed results—e.g., a location estimate for the UE 601. In one embodiment, at step 5b, if step 1b occurred, the AMF 133 uses (see block 618) the location service response received in step 4 to assist the service that triggered this in step 1b (e.g., may provide a location estimate associated with an emergency call to a GMLC). At step 5c, in one embodiment, if step 1c was performed, the AMF 133 returns a location service response to the UE 601 and includes any needed results—e.g., a location estimate for the UE 601.

Location procedures applicable to NG-RAN, in one embodiment, occur in steps 3a and 3b in FIG. 6. Other steps in FIG. 6 are applicable to the 5GC and are described in greater detail in TS 23.502 and TS 23.273. In one embodiment, steps 3a and 3b involve the use of different positioning methods to obtain location related measurements for a target UE and from these computes a location estimate and possibly additional information like velocity.

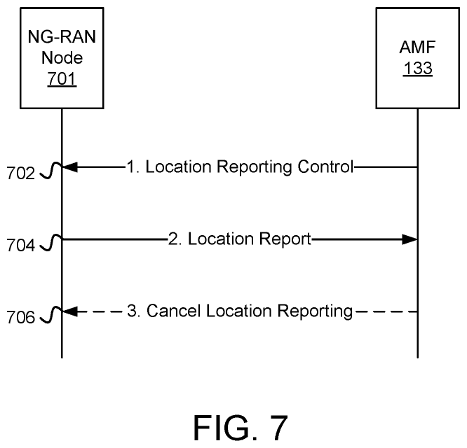

FIG. 7 depicts a procedure flow for NG-RAN location reporting procedures, e.g., as described in TS 23.502. In one embodiment, the depicted procedure is used by an AMF 133 to request the NG-RAN 701 to report where the UE is currently located when the target UE is in CM-CONNECTED state. The need for the NG-RAN 701 to continue reporting ceases when the UE transitions to CM-IDLE or the AMF 133 sends cancel indication to NG-RAN 701. This procedure may be used for services that require accurate cell identification (e.g., emergency services, lawful intercept, charging), or for subscription to the service by other NFs. When Dual Connectivity is activated, PSCell information is only reported if requested by the AMF 133.

At step 1, in one embodiment, the AMF 133 sends (see messaging 702) a Location Reporting Control message to the NG-RAN 701. The Location Reporting Control message shall identify the UE for which reports are requested and shall include Reporting Type and Location Reporting Level. The Location Reporting Control message may also include Area of Interest and Request Reference ID. Location Reporting Level could be TAI+ Cell Identity. Reporting Type indicates whether the message is intended to trigger a single standalone report about the current Cell Identity serving the UE or start the NG-RAN 701 to report whenever the UE changes cell or ask the NG-RAN 701 to report whenever the UE moves out or into the Area of Interest. If the Reporting Type indicates to report whenever the UE changes cell and if PScell reporting is requested and Dual Connectivity is in use, the Master RAN node shall also report to the AMF 133 whenever the PSCell changes. If the Reporting Type indicates to start the NG-RAN 701 to report when UE moves out of or into the Area of Interest, the AMF 133 also provides the requested Area of Interest information in the Location Reporting Control message. The AMF 133 may include a Request Reference ID in the Location Report Control message to identify the request of reporting for an Area of Interest. If multiple Areas of Interest are included in the message, the Request Reference ID identifies each Area of Interest.

It is noted that requesting reports whenever the UE changes cell can increase signaling load on multiple interfaces. Requesting reports for all changes in PSCell ID can further increase signaling load. Hence it is recommended that any such reporting is only applied for a limited number of subscribers.

At step 2, in one embodiment, the NG-RAN 701 sends (see messaging 704) a Location Report message informing the AMF 133 about the location of the UE which shall be represented as the requested Location Reporting Level. If PSCell reporting is requested and Dual Connectivity is activated, then the Master NG-RAN node shall also include the PSCell ID. With NR satellite access, cell and TAI reporting by NG-RAN refer to a fixed cell and fixed TA in which a UE is geographically located. As part of the User Location Information, NG_RAN also reports one or more tracking area codes (“TACs”) for the Selected PLMN, e.g., as described in TS 38.413, but it is not guaranteed that the UE is always located in one of these TACs.

When the UE is in CM-CONNECTED with RRC Inactive state, if NG-RAN 701 has received Location Reporting Control message from AMF 133 with the Reporting Type indicating single stand-alone report, the NG-RAN 701 shall perform NG-RAN paging before reporting the location to the AMF 133. The NG-RAN 701 should send the Location Report promptly and shall not wait to attempt to create a Dual Connectivity configuration. However, if PSCell reporting is requested and the PSCell ID is known to the Master RAN node, then it shall be included in the Location Report. In the case of RAN paging failure, the RAN reports UE's last known location with time stamp.

When the UE is in CM-CONNECTED with RRC Inactive state, if NG-RAN 701 has received Location Reporting Control message from AMF 133 with the Reporting Type indicating continuous reporting whenever the UE changes cell, the NG-RAN 701 shall send a Location Report message to the AMF 133 including the UE's last known location with time stamp. If the UE was using Dual Connectivity immediately before entering CM-CONNECTED with RRC Inactive state and PSCell reporting is requested, then the Location Report shall also include the PSCell ID.

When the UE is in CM-CONNECTED, if NG-RAN 701 has received Location Reporting Control message from AMF 133 with the Reporting Type of Area of Interest based reporting, the NG-RAN 701 shall track the UE presence in Area of Interest and send a Location Report message to AMF 133 including the UE Presence in the Area of Interest (e.g., IN, OUT, or UNKNOWN) as described in clause D.2 and the UE's current location (including the PSCell ID if PSCell reporting is requested and Dual Connectivity is activated) when the UE is in RRC Connected state, or, when the UE is in RRC Inactive state, the UE's last known location (including the PSCell ID if PSCell reporting is requested and the UE was using Dual Connectivity immediately before entering CM-CONNECTED with RRC Inactive state) with time stamp if the NG-RAN 701 perceives that the UE presence in the Area of Interest is different from the last one reported. When the NG-RAN 701 detects that the UE has moved out of or into multiple areas of interest, it sends multiple pairs of UE Presence in the Area of Interest and the Request Reference ID in one Location Report message to AMF 133. If UE transitions from RRC Inactive state to RRC Connected state, NG-RAN 701 shall check the latest location (including the PSCell ID if PSCell reporting is requested and Dual Connectivity is activated) of UE and follow the rules when UE is in RRC Connected.

The AMF 133 may receive Location Report even if the UE presence in Area of Interest is not changed. The AMF 133 stores the latest received PSCell ID with its associated timestamp. The AMF 133 stores the latest received PSCell ID with its associated timestamp, when available.

In one embodiment, at step 3, the AMF 133 can send a Cancel Location Reporting message to inform the NG-RAN 701 that it should terminate the location reporting for a given UE corresponding to the Reporting Type or the location reporting for Area of Interest indicated by Request Reference ID. This message is needed when the reporting type was requested for continuously reporting or for the Area of Interest. The AMF 133 may include the Request Reference ID which indicates the requested Location Reporting Control for the Area of Interest, so that the NG-RAN 701 should terminate the location reporting for the Area of Interest. It is noted that location reporting related information of the source NG-RAN node is transferred to the target NG-RAN node during Xn handover.

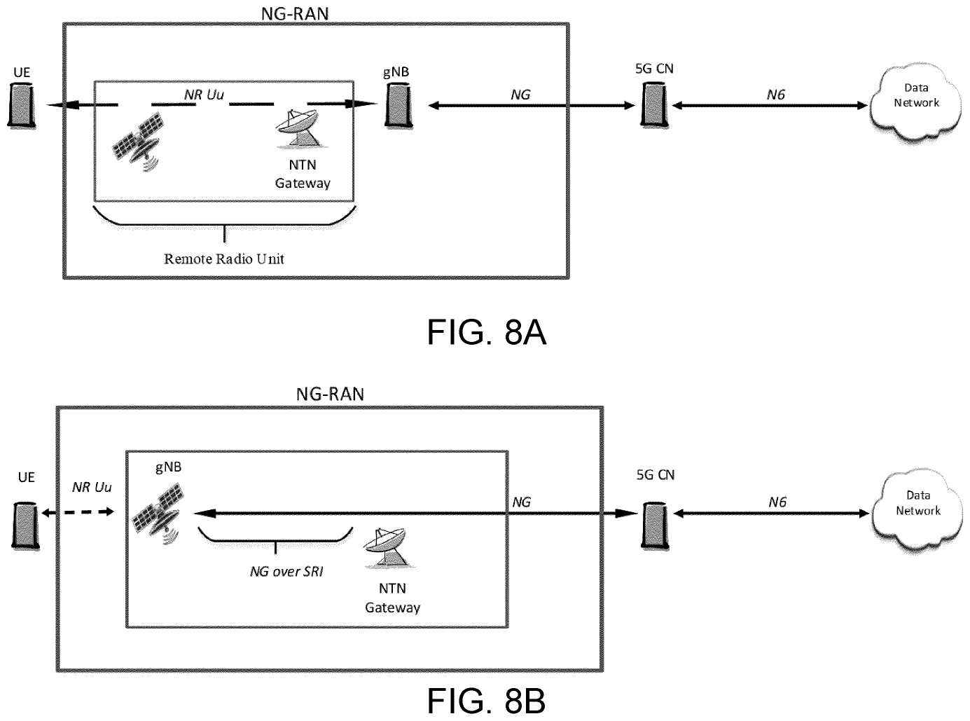

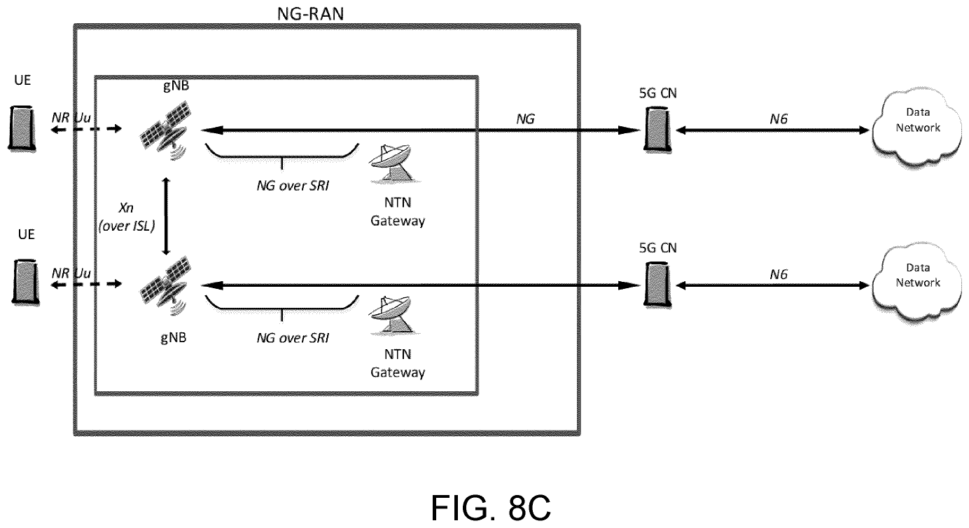

FIG. 8A depicts one embodiment of a transparent satellite-based NG-RAN architecture. In the depicted embodiment, the satellite payload implements frequency conversion and a Radio Frequency amplifier in both up link and down link direction. It corresponds to an analogue RF repeater. Hence the satellite 802 repeats the NR-Uu 804 radio interface from the feeder link (between the NTN gateway 806 and the satellite 802) to the service link (between the satellite 802 and the UE 810) and vice versa. The Satellite Radio Interface (“SRI”) on the feeder link is the NR-Uu 804. In other words, the satellite does not terminate NR-Uu 804. The NTN GW 806 supports all necessary functions to forward the signal of NR-Uu 804 interface. Different transparent satellites may be connected to the same gNB 808 on the ground. It is noted that while several gNBs 808 may access a single satellite payload, the description has been simplified to a unique gNB 808 accessing the satellite payload, without loss of generality.

FIG. 8B depicts one embodiment of a regenerative satellite-based NG-RAN architectures without ISL. In one embodiment, the NG-RAN logical architecture as described in TS 38.401 is used as baseline for NTN scenarios. The satellite payload implements regeneration of the signals received from Earth. The NR-Uu 804 radio interface is the service link between the UE 810 and the satellite 802 and the SRI 812 on the feeder link between the NTN gateway 806 and the satellite 802. SRI 812 is a transport link between NTN GW 806 and satellite 802. It is noted that the satellite 802 may embark additional traffic routing functions that are out of RAN scope. The satellite payload also provides ISL between satellites. ISL is a transport link between satellites. ISL may be a radio interface or an optical interface that may be 3GPP or non 3GPP defined but this is out of the study item scope. The NTN GW 806 is a Transport Network Layer node and supports all necessary transport protocol.

FIG. 8C depicts one embodiment of a regenerative satellite-based NG-RAN architectures with ISL. FIG. 8C illustrates that a UE 810 served by a gNB 808 on board a satellite 802 could access the 5GCN 814 via ISL. The gNB 808 on board different satellites 802 may be connected to the same 5GCN 814 on the ground. If the satellite 802 hosts more than one gNB 808, the same SRI 812 will transport all the corresponding NG interface instances.

In general, the solutions disclosed herein provide various solution enhancement for enabling network verified location of the target-UE. In one embodiment, solutions are disclosed for enabling the AMF to transmit a UE location verification request to an NG-RAN node equipped with an LMC in order to have low latency verification process, whereas verification may either be performed by the LMC or by the AMF.

In one embodiment, solutions are disclosed for enabling the AMF to trigger a network-induced location procedure where a location estimate based on a specific position methodology (e.g., RAT-dependent or RAT-independent) is configured. In one embodiment, solutions are disclosed to first verify a UE location by AMF by employing RAT-dependent techniques and then verifying a secondary location estimate using RAT-independent methods by comparing it to the first location estimate using RAT-dependent methods.

In one embodiment, solutions are disclosed to trigger the LMF to initiate network verification location procedures using NTN RAT-dependent positioning techniques. It is noted that the various embodiments disclosed below may be implemented in combination with each other to support NR positioning using the supported NTN interfaces and network entities/nodes. In one embodiment, for the purposes of this disclosure, a positioning-related reference signal may refer to a reference signal used for positioning procedures/purposes to estimate a target-UE's location, e.g., PRS, or based on existing reference signals such as SRS and a target-UE can be referred to as the device/entity to be localized/positioned. In one embodiment, a target-UE is referred to as the UE of interest in which the position is to be calculated by the network or the target-UE itself. Furthermore, subject matter disclosed in Lenovo Patent Application SMM020220103-GR-NP (IDF-153114) are incorporated herein by reference and may be implemented in combination with the embodiments in this disclosure.

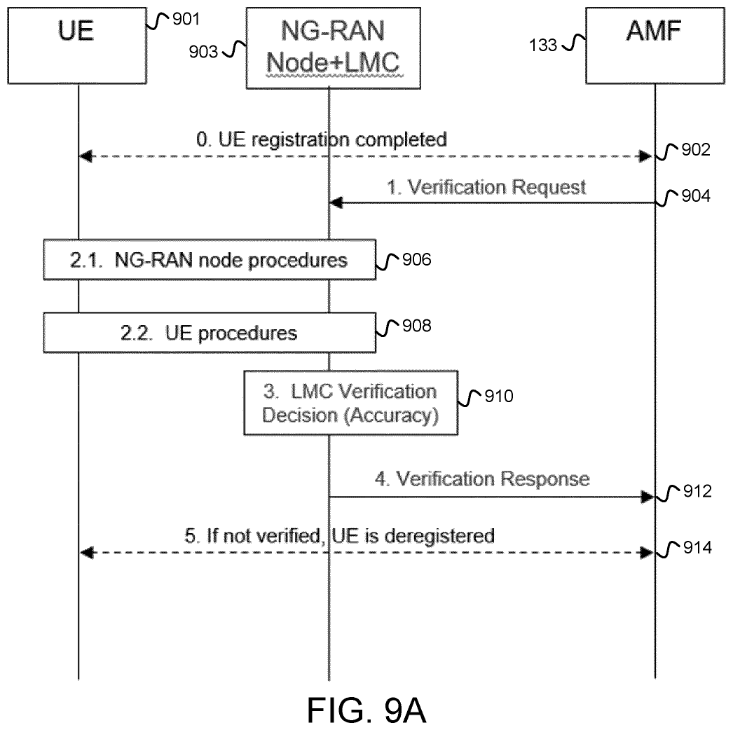

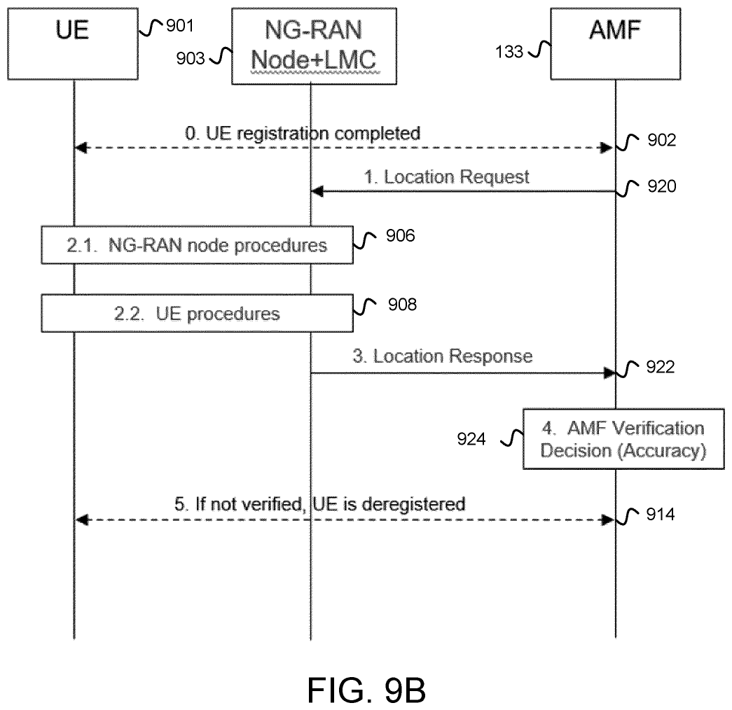

In a first embodiment directed to low-latency verification based on LMC in NG-RAN, as shown in FIG. 9A, after UE registration is completed in step 0 (see messaging 902), the AMF 133 transmits, at step 1 (see messaging 904), a UE location verification request to an NG-RAN node 903 equipped with an LMC. This could also be applicable to the scenario that the LMF is co-located with the NG-RAN node 903, where such implementation may be more common in NTN networks to avoid long propagation delays and thus enhance the location accuracy. Such an implementation implies that the gateway and the NTN-gNB could be equipped with LMC functionality or be co-located with the LMF.

In one embodiment, at steps 2.1 and 2.2, NG-RAN node procedures (see block 906) and UE procedures (see block 908) are performed. In one embodiment, at step 3, the LMC at the NG-RAN node 903 performs (see block 910) the LMC verification decision. In such an embodiment, the LMC comprises the full or partial set of functionalities of the LMF including positioning capability exchange, PRS/SRS resource configuration, choice of positioning methods, positioning measurement configuration and reporting procedures. Such an implementation offers a low latency approach to the verification process whereby the NG-RAN and LMC (Location Management Component) coordinate the determination of the UE's 901 location using RAT-dependent and/or RAT-independent methods, while also performing the verification. In one embodiment, at step 4, the verification response message is sent (see messaging 912) to the AMF 133, and if not verified, the UE 901 is deregistered (see process 914).

FIG. 9B depicts another procedure flow directed to low latency verification using NG-RAN and LMC combined functionality. The procedure depicted in FIG. 9B may be substantially similar to the procedure depicted in FIG. 9A, with the difference being that the AMF 133 sends a location request at step 1 (see messaging 920) to the NG-RAN/LMC 903 to request the UE's 901 location estimate, receives a location response from the NG-RAN/LMC 903 at step 3 (see messaging 922), and performs the verification decision at step 4 (see block 924) based on the location estimate.

In one implementation, the location request or verification message by the AMF 133 to the NG-RAN/LMC 903 is sent using Nlmf_Location_DetermineLocation service operation, where such message may explicitly contain an indication for RAT-dependent method based location request or a field indicating a verification request. In case there is a field indicating a verification procedure, the NG-RAN/LMC 903 may employ only RAT-dependent methods. Based on the indicated request (a verification procedure or location estimates), the NG-RAN/LMC 903 performs the respective operation. Once the indicated service operation has been accomplished, the NG-RAN/LMC 903 may send a Nlmf_Location_DetermineLocation response message, indicating the verification or location request.

In one implementation, a new signaling procedure for verification of the target UE 901 location is adopted, where this procedure is based on request/response messages, e.g., Namf_location_verification request and response messages containing information related to the verification procedure of the targeted UE 901 location.

In a second embodiment, directed to network induced (e.g., AMF to LMF and LMF to AMF) location procedures with a method type, the AMF invokes a location service operation to the LMF where in addition to services such as quality of service and serving cell identity, it explicitly includes information about type of methods to be utilized for the location estimation, e.g., RAT-independent or RAT-dependent. Such information may be necessary for UE REPORTED location verification purposes as some methods may not be considered reliable (e.g., GNSS due to spoofing) or some methods may not be valid or accurate for a given scenario (e.g., triangulation based methods, Cell ID based methods, or even RTT based methods in NTN). In addition, the AMF may require a location based on a specific type of positioning method either to compare the results with some previous location achieved with other methods, to verify it with a reliable method, or to avoid long processing delays in location estimations.

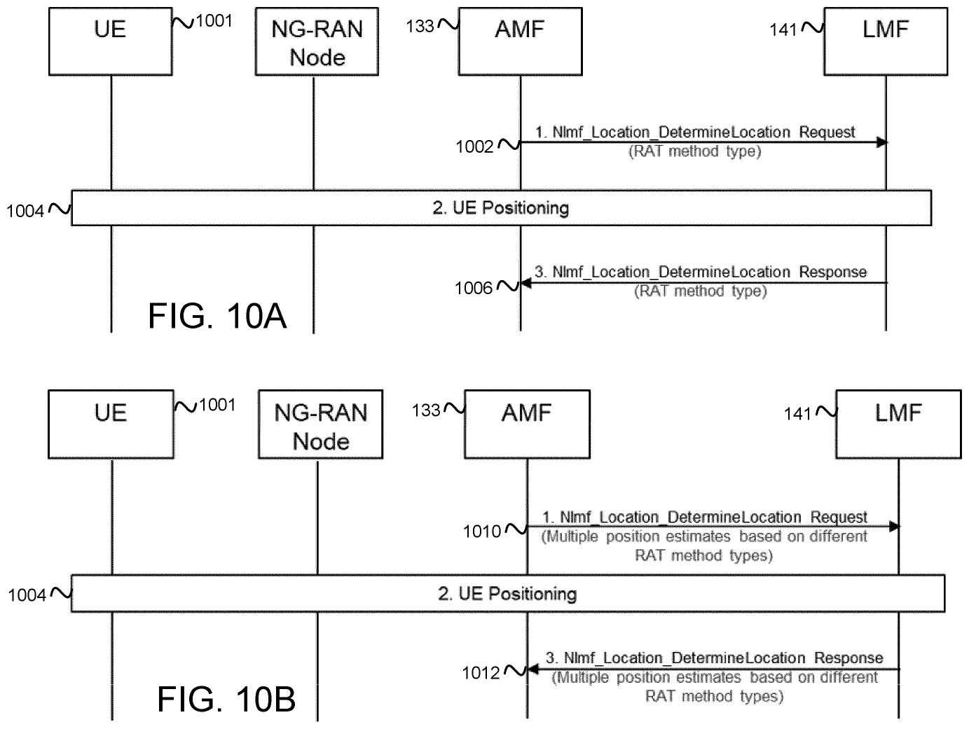

In one example embodiment, shown in FIG. 10A, at step 1, the AMF 133 initiates a UE location request (see messaging 1002) to the LMF 141 using Nlmf_Location_DetermineLocation service operation where this service operation includes an explicit field (for example namely “RAT_method_type”) to indicate the type of method to be used for location determination. In one implementation, the field may indicate to use either RAT-independent methods or RAT-dependent methods for the location estimation purposes, whereas the choice of the method to be used is left to the LMF 141. In another implementation, the field indicates one or a set of methods that are to be used for UE location determination. For example, the AMF 133 may have the knowledge of UE positioning capabilities and based on this information, indicates which type of method is to be utilized or the AMF 133 may know that the UE 1001 is connected through a single satellite, so in this case, single satellite-based positioning methods are to be used. Therefore, the AMF 133 may indicate to the LMF 141 to choose one of the methods from a set of applicable methods.

In one embodiment, the information about the type of method to be used by the LMF 141 may be embedded in LCS QoS information. For example, a new QoS class may be specified for location verification purposes for NTN, where such class includes methods that fulfill the verification accuracy requirements of the NTN system (e.g., 5˜10 km) and exclude those methods that still fulfill the accuracy but are not reliable (e.g., GNSS). In such a case, the LMF decision about the positioning method is determined by QoS criteria. In one example, the response time field in LCS QoS information may also determine the methods to be employed and may be read along with the QoS class. For example, a large response and NTN verification QoS may mean a RAT-dependent method and short response time may mean a RAT-independent method such as GNSS.

In one embodiment, a new field is included in the request message that indicates that the location estimates are for verification purposes. In such a scenario, the LMF 141 complies to RAT-dependent methods for the location estimates and the selection of corresponding RAT-dependent positioning methods (RTT, AoA, or the like) would be carried out by LMF 141.

Based on the received request from AMF 133, the LMF 141 performs one or more positioning procedures that are indicated in the LMF request message, as shown in step 2 of FIG. 10A (see block 1004). If the AMF 133 indicates a specific positioning method, the LMF 141 initiates positioning procedures according to that method. Otherwise, the LMF 141 may choose any RAT method procedure. In such an embodiment, the LMF 141 selects a method based on set of defined parameters and initiates the procedure. The LMF 141 positioning procedures may either be UE assisted and/or UE based positioning procedures that are triggered by employing LTE positioning protocol (“LPP”) or may be network assisted and/or network based positioning that are based on an NR positioning protocol A (“NRPPa”) protocol.

In one embodiment, the estimated current position of the targeted UE is returned to the AMF 133 by the LMF 141 using the Nlmf_Location_DetermineLocation response message, step 3 in FIG. 10A (see messaging 1006). The service operation may include the LCS correlation identifier, the location estimates with the timestamp, and the positioning method employed. In one embodiment, the UE 1001 may not have the capability of the positioning method that has been requested by the AMF 133. In such an embodiment, the LMF 141 may initiate a Nlmf_Location_DetermineLocation response message with a field saying that the requested method is not supported. In addition, the LMF 141 may also include the alternative UE positioning capabilities/methods in the same message.

In one embodiment, the request message may contain a field indicating that the location estimate, and the verification procedures are to be done by the configured network entity (e.g., LMF, LMC). In such a case, both the location estimate, and verification procedure may be carried out by the configured entity. The configured network entity may use a positioning procedure from RAT dependent methods. Upon completion of the verification procedure, the response message would be sent and would either contain both the location estimate (and related information, e.g., positioning methods) and verification results (e.g., whether the verification is successful or not) of the targeted UE or would only contain the information about verification results (e.g., whether the verification is successful or not).

In one embodiment, shown in FIG. 10B, the AMF 133, using Nlmf_Location_DetermineLocation service operation, may request the LMF 141 to estimate and report multiple UE locations with multiple method types (RAT dependent and RAT independent), where each location estimate corresponds to one positioning method, as shown in step 1 of FIG. 10B (see messaging 1010). For example, the AMF 133 may ask for two location estimates based on RAT dependent and RAT independent positioning procedures.

In such an embodiment, the field RAT_method_type may indicate multiple method types. Such a procedure may be beneficial in reducing the latency especially in NTN, as multiple location estimates with different method types may be needed to verify the UE locations. Upon receiving the AMF 133 request to estimate and report multiple location estimates with different method types, the LMF 141 initiates the positioning procedures at step 2 (see block 1004). Once the LMF 141 has the UE's current location corresponding to different methods, the LMF 141 may invoke a Nlmf_Location_DetermineLocation response message at step 3 (see messaging 1012), where in addition to other information such as LCS correlation identifier, the LMF 141 indicates multiple location estimates with a timestamp and also the corresponding positioning method with which the location is estimated.

In a third embodiment, directed to an AMF initiated location and verification procedure based on multiple location estimates with different RAT method types, after the UE registration has been completed and there is no information about UE location in the registration process, the AMF initiates two location request messages to the LMF for a location estimate using a RAT dependent method and a RAT independent method where the AMF verifies the first location estimates (RAT independent method) by a second location estimates that are gained by employing RAT dependent methods. In one embodiment, the idea is to have a first location estimate that may be based on a RAT independent method, e.g., GNSS location, and if verified by the second location estimate that are generated by reliable RAT dependent method, then the network may consider the first RAT independent method (e.g., GNSS) a reliable method and further use it to either to improve location estimates for that respective UE or later use it for emergency services (if needed).

In one implementation, the AMF that initiates the location procedure also performs the verification process. In one implementation, the AMF that initiates the location reporting procedure may differ from the AMF that does the verification procedure. In another implementation, the AMF that initiates the location reporting and verification procedure, may only be the serving AMF (based on a single PLMN) to NTN NG-RAN node. In an alternative implementation, any AMF may initiate the location reporting and verification procedure. In yet another implementation, different AMFs may initiate separate location reporting request for different methods in parallel.

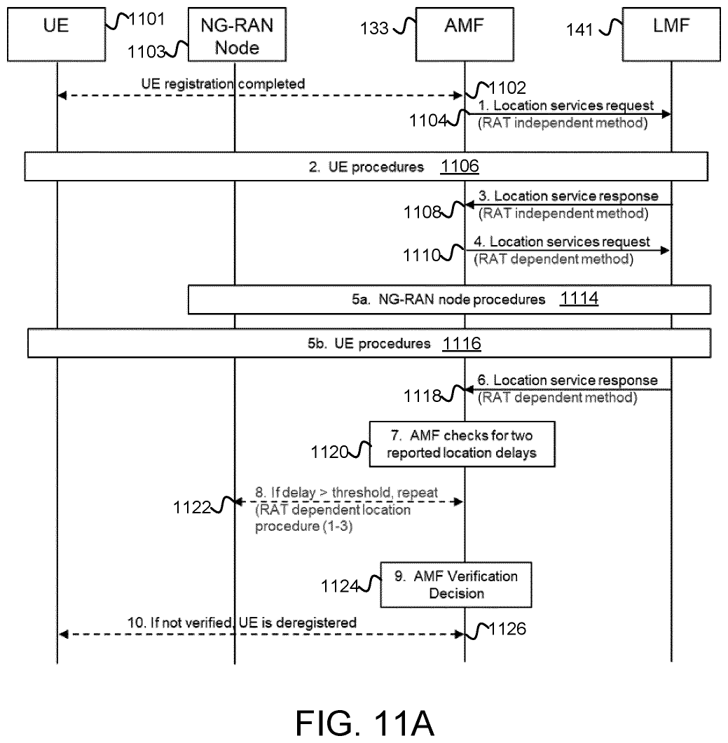

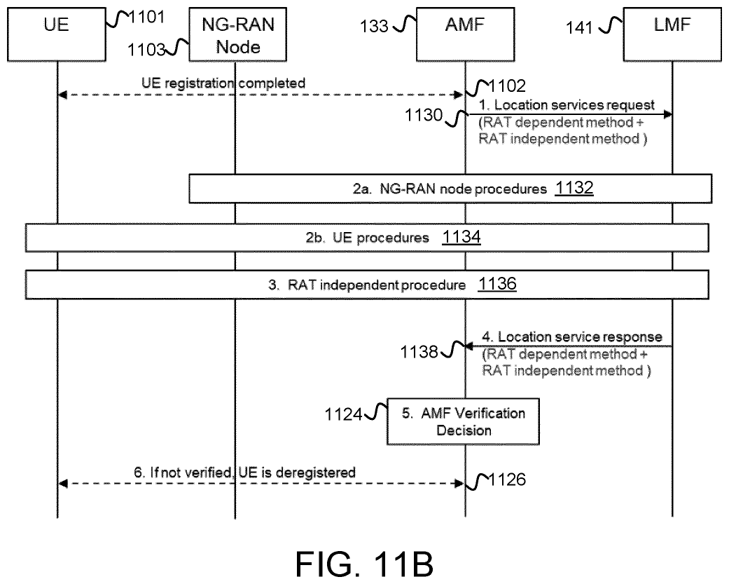

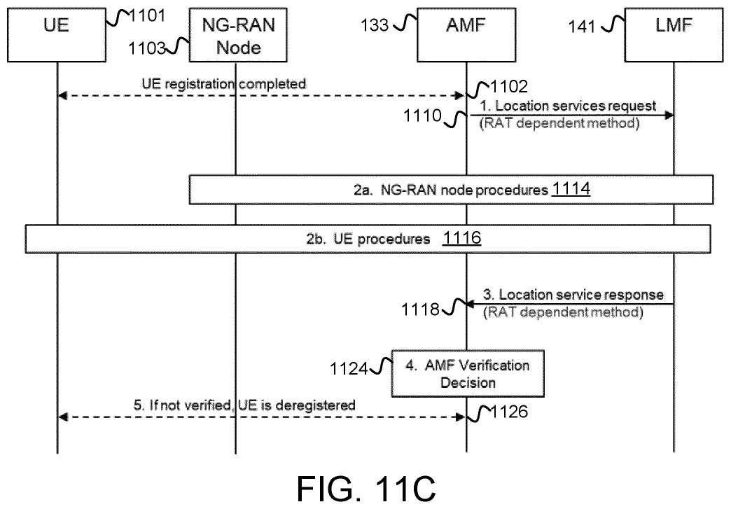

In one embodiment, the AMF initiates the location service procedure for two location estimates with different method types in a sequential order, as shown in FIG. 11A. At step 1, after UE registration 1102 is complete and there is no information of UE location in the registration process, the AMF 133 initiates (see messaging 1104) a first location request message, e.g., Nlmf_Location_DetermineLocation, towards the LMF 141 to request the current location of the UE 1101 and to employ a RAT independent method to estimate this location. Therefore, the service operation includes an LCS Correlation identifier, the serving cell identity of the Primary Cell in the Master RAN node and the Primary Cell in the Secondary RAN node, when available, based on Dual Connectivity scenarios, and an indication of a location request from a regulatory services client (e.g., emergency services) and may include an indication of whether the UE 1101 supports LPP, the required QoS and Supported GAD shapes, the UE Positioning Capability if available, and the location method type that needs to be employed for location estimate, e.g., RAT independent method. The indication of method type may be generic where the LMF 141 selects one of the positioning methods or may be explicitly specified in the request message (e.g., GNSS).

At step 2, in one embodiment, based on the indicated method type field, the LMF 141 triggers a RAT-independent location procedure (see block 1106) with NTN NG-RAN nodes 1103 and the UE 1101, where the LMF 141 either selects the suitable procedure from a list of RAT independent procedures in case there is no specific method indicated or otherwise employ the specified method.

At step 3, in one embodiment, when the UE's current location is estimated using a RAT independent method, the LMF 141 informs (see messaging 1108) the AMF 133 about the current location of the UE by using the Nlmf_Location_DetermineLocation response message. In addition to the location estimate, the message includes the method type used for location estimation (in case the positioning method is not specified in request message and selected by the LMF 141), the time stamp of the location estimate, and the accuracy. Additional information about the UE capability regarding employment of RAT dependent methods, such as single satellite or multiple satellite coverage, may also be included in the message. Such information may be helpful to the network to select a suitable RAT dependent method for verification. In such an embodiment, the 133 AMF assigns a specific RAT independent method type and if the UE 1101 does not have the capability for that method, the response method would indicate to the AMF 133 that the UE 1101 does not have the capability of the requested positioning method type.

At step 4, in one embodiment, the AMF 133 transmits (see messaging 1110) a second location service request to the LMF 141 using a Nlmf_Location_DetermineLocation request message that specifies that a RAT dependent procedure for location estimation of the target UE 1101 is to be used. The request message may contain an indication of the method type, while the LMF 141 may decide which RAT dependent positioning method needs to be implemented. The LMF 141 may include the parameters discussed in step 1 or only specify the location method type. In case there are no additional parameters, the LMF 141 may assume that parameters described in the first step are also valid for the second location service request message.

At steps 5a and 5b, in one embodiment, the LMF 141 initiates the RAT-dependent location procedures with the NTN NG-RAN 1103 nodes and UE 1101. In one embodiment, at step 5a, the LMF 141 instigates location procedures with the serving and possibly neighboring NTN gNBs in the NG-RAN 1103 (see block 1114) (applicable to both the transparent and regenerative payload architectures), e.g., to perform PRS/SRS resource requests, to obtain positioning measurements, where the location procedures are RAT-dependent. This can be also applicable for the single and multi-satellite case. Examples may include the use of network-based positioning methods that rely on the NRPPa protocol such as to exchange NTN gNB measurements or the like.

At step 5b, in one embodiment, the LMF 141 instigates location procedures, e.g., via LPP with the UE 1101 (see block 1116), e.g., to exchange NTN capability information, provide NTN assistance data configuration, NTN location measurement configurations, NTN location information reports (including location estimate or positioning measurements) as well as error/abort messages. The modes of location estimation may include UE-assisted based positioning procedures; although, in other implementations, UE-based positioning procedures to determine the UE's location are not precluded.

At step 6, in one embodiment, the LMF 141 provides (see messaging 1118) a second location service response to the AMF 133 to indicate the RAT dependent location of the target UE 1101 by making use of the Nlmf_Location_DetermineLocation response message. The message may include the method type and time stamp of UE location estimates.

At step 7, in one embodiment, upon receiving the RAT dependent location estimate, the AMF 133 compares (see block 1120) the time stamp of two location estimates to check for reported location delays as the RAT dependent method may take longer and the difference between the two location estimates may be higher than the predefined threshold. In such a case, the network may assume that RAT independent method is not reliable and does not use it further.

At step 8, in one embodiment, if the delay between first and second location estimates is greater than the predefined threshold, then the first location estimation process (see process 1122) may be repeated by initiating a third network induced request to the LMF 141 and so on (repeat steps 1-3).

At step 9, in one embodiment, the AMF 133 verifies (see block 1124) the UE location based on the predefined criteria and by using the RAT dependent location estimates. The criteria may include the geographical coordinates for the requested service (e.g., the UE 1101 is in the desired location of the requested service). If successful, no further actions may be needed. In addition to verifying the UE location, the AMF 133 may compare the two location estimates from RAT dependent and RAT independent methods. If the RAT independent location is within the predefined margin of the RAT dependent location, the AMF 133 may consider the RAT independent method as reliable and may further use it as a standalone positioning method for emergency services or for positioning accuracy enhancements.

At step 10, in one embodiment, if the UE location verification is successful, the UE continues to maintain its connection with the network. Otherwise, if the UE location verification fails, the UE 1101 is deregistered from the network (see process 1126).

In one embodiment, latency in the location estimation and verification procedure, discussed above, may further be reduced by using one network induced location service request message, requesting both RAT independent and RAT dependent locations to the LMF 141 in a single message (as discussed above in embodiment 1). Accordingly, steps 1 and 4 in FIG. 11A, discussed above, can be combined, as shown at step 1 of FIG. 11B (see messaging 1130). Upon reception of this request message, the LMF 141 initiates the RAT-dependent location procedures with the NTN NG-RAN nodes 1103 at step 2a (see block 1132) and the UE 1101 at step 2b (see block 1134), and, in parallel, may also initiate the RAT-independent location procedures, as described above in steps 2 and 5 of FIG. 11A (see step 3 at block 1136 of FIG. 11B).

Once the location estimates have been computed for both methods, in one embodiment, at step 4, the LMF 141 may initiate (see messaging 1138) one location response message, indicating two location estimates with timestamps and corresponding computing methods (combining steps 3 and 6 in FIG. 11A). Such procedure also reduce the delay between two location estimates. In one embodiment, at step 5, the AMF 133 may check (see block 1124) the delay between two location estimates and once its within range, may verify the UE location and also check the reliability of RAT independent method.

In one embodiment, shown in FIG. 11C, the UE 1101 may first verify the target UE location by initiating first the RAT dependent location request message to the LMF 141 and based on the received location estimate response by the LMF 141, the AMF 133 verifies the target UE location based on set criteria (e.g., the UE 1101 is in the desired geographical area). If the UE location verification is successful, the UE 1101 continues to maintain its connection with the network. If the UE location verification fails, the UE is deregistered from the network. In one implementation, the process stops here, as illustrated in FIG. 11C. Basically steps 4 (messaging 1110), 5 (blocks 1114 and 1116), 6 (messaging 1118), 9 (block 1124), and 10 (process 1126) from FIG. 11A are employed while the signaling remains the same.

In one embodiment, the AMF 133 does not utilize a field to indicate the type of method to be employed (RAT dependent or RAT independent), rather a field may be used to indicate to the LMF 141 that location estimates are for positioning verification purposes. In such an embodiment, the LMF 141 initiates the location procedure based on RAT dependent methods and specifies in the response message the location method that is used for location estimates of the target UE 1101.

In one example, the AMF 133 may initiate a second location request message for the RAT independent methods, after the location verification has been carried out (using RAT dependent methods). If the location estimates of the RAT independent method are within the predefined set of threshold values, the AMF 133 may consider the RAT dependent method as a reliable method (e.g., not subject to spoofing) and may further use it to enhance the positioning accuracy or to use it in future for emergency or regulatory services.

According to a fourth embodiment directed to LMF initiated location reporting and verification procedure after UE Registration, the LMF 141 receives a request to perform network verification of the UE's location. In this implementation, the LMF 141 is responsible for the verification of the UE's location by acting as a consumer of the location and performing the verification procedures. The LMF 141 may consider the following options to verify the UE's location:
RAT-dependent positioning methods;
RAT-independent positioning methods; and/or
Hybrid Positioning methods including a combination of both RAT-dependent and RAT-independent positioning methods.

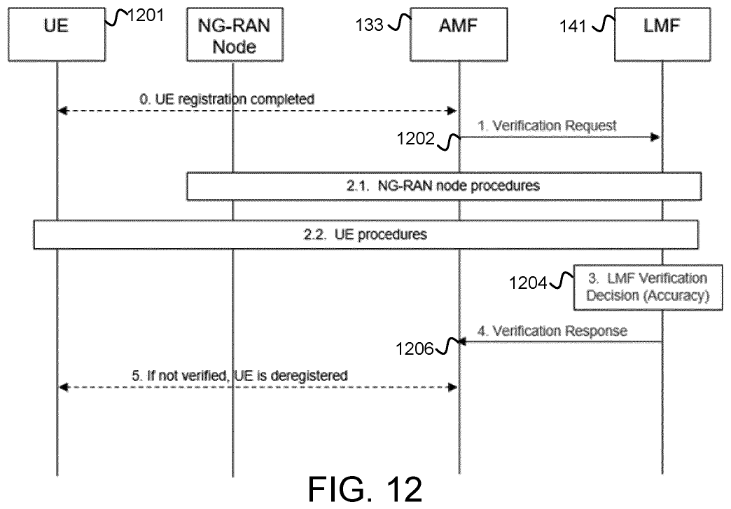

As shown in FIG. 12, according to steps 1 and 4, the AMF 133 transmits (see messaging 1202) a verification request and receives (see messaging 1206) a verification response, respectively. The verification request may include a field to indicate whether the verification is based on the RAT-type and number of NTN satellites connected to the UE 1201. The verification response may include a single field on whether the verification is the UE 1201 is successful or unsuccessful.

In one embodiment, according to the step 3, the LMF 141 may combine (see block 1204) the results from one or more of the different RAT-type positioning methods to verify the UE's accuracy. This verification may be associated with a validity time or area restriction, which can be transmitted along with the verification response in step 4.

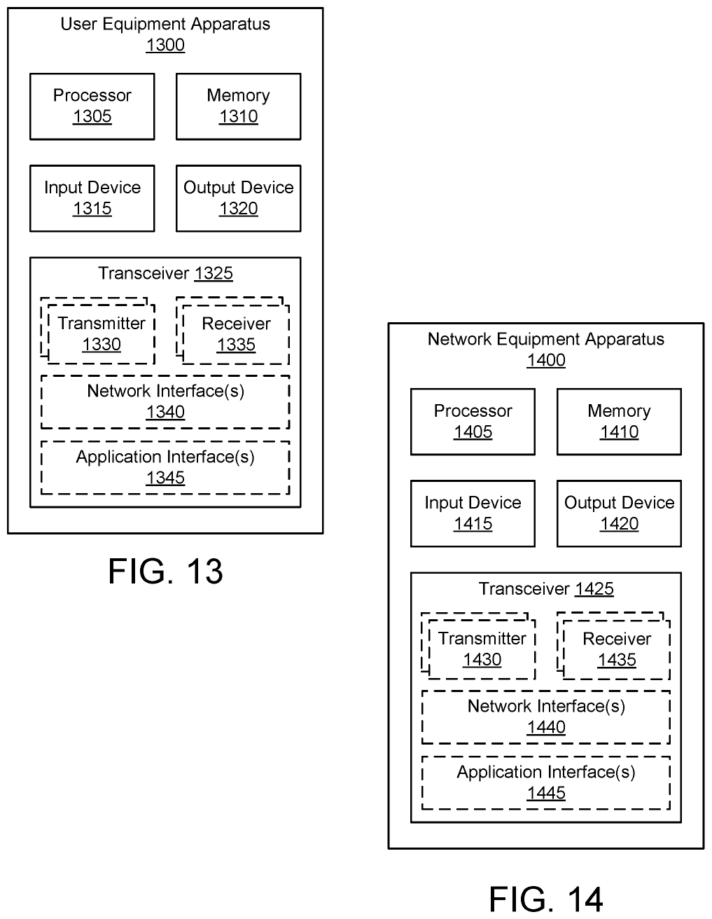

FIG. 13 depicts a user equipment apparatus 1300 that may be used for low-latency NTN-based UE location verification, according to embodiments of the disclosure. In various embodiments, the user equipment apparatus 1300 is used to implement one or more of the solutions described above. The user equipment apparatus 1300 may be one embodiment of a UE, such as the remote unit 105 and/or the UE 205, as described above. Furthermore, the user equipment apparatus 1300 may include a processor 1305, a memory 1310, an input device 1315, an output device 1320, and a transceiver 1325. In some embodiments, the input device 1315 and the output device 1320 are combined into a single device, such as a touchscreen. In certain embodiments, the user equipment apparatus 1300 may not include any input device 1315 and/or output device 1320. In various embodiments, the user equipment apparatus 1300 may include one or more of: the processor 1305, the memory 1310, and the transceiver 1325, and may not include the input device 1315 and/or the output device 1320.

As depicted, the transceiver 1325 includes at least one transmitter 1330 and at least one receiver 1335. Here, the transceiver 1325 communicates with one or more base units 121. Additionally, the transceiver 1325 may support at least one network interface 1340 and/or application interface 1345. The application interface(s) 1345 may support one or more APIs. The network interface(s) 1340 may support 3GPP reference points, such as Uu and PC5. Other network interfaces 1340 may be supported, as understood by one of ordinary skill in the art.

The processor 1305, in one embodiment, may include any known controller capable of executing computer-readable instructions and/or capable of performing logical operations. For example, the processor 1305 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1305 executes instructions stored in the memory 1310 to perform the methods and routines described herein. The processor 1305 is communicatively coupled to the memory 1310, the input device 1315, the output device 1320, and the transceiver 1325. In certain embodiments, the processor 1305 may include an application processor (also known as “main processor”) which manages application-domain and operating system (“OS”) functions and a baseband processor (also known as “baseband radio processor”) which manages radio functions.

The memory 1310, in one embodiment, is a computer readable storage medium. In some embodiments, the memory 1310 includes volatile computer storage media. For example, the memory 1310 may include a RAM, including dynamic RAM (“DRAM”), synchronous dynamic RAM (“SDRAM”), and/or static RAM (“SRAM”). In some embodiments, the memory 1310 includes non-volatile computer storage media. For example, the memory 1310 may include a hard disk drive, a flash memory, or any other suitable non-volatile computer storage device. In some embodiments, the memory 1310 includes both volatile and non-volatile computer storage media.

In some embodiments, the memory 1310 stores data related to CSI enhancements for higher frequencies. For example, the memory 1310 may store parameters, configurations, resource assignments, policies, and the like as described above. In certain embodiments, the memory 1310 also stores program code and related data, such as an operating system or other controller algorithms operating on the user equipment apparatus 1300, and one or more software applications.

The input device 1315, in one embodiment, may include any known computer input device including a touch panel, a button, a keyboard, a stylus, a microphone, or the like. In some embodiments, the input device 1315 may be integrated with the output device 1320, for example, as a touchscreen or similar touch-sensitive display. In some embodiments, the input device 1315 includes a touchscreen such that text may be input using a virtual keyboard displayed on the touchscreen and/or by handwriting on the touchscreen. In some embodiments, the input device 1315 includes two or more different devices, such as a keyboard and a touch panel.

The output device 1320, in one embodiment, is designed to output visual, audible, and/or haptic signals. In some embodiments, the output device 1320 includes an electronically controllable display or display device capable of outputting visual data to a user. For example, the output device 1320 may include, but is not limited to, an LCD display, an LED display, an OLED display, a projector, or similar display device capable of outputting images, text, or the like to a user. As another, non-limiting, example, the output device 1320 may include a wearable display separate from, but communicatively coupled to, the rest of the user equipment apparatus 1300, such as a smart watch, smart glasses, a heads-up display, or the like. Further, the output device 1320 may be a component of a smart phone, a personal digital assistant, a television, a table computer, a notebook (laptop) computer, a personal computer, a vehicle dashboard, or the like.

In certain embodiments, the output device 1320 includes one or more speakers for producing sound. For example, the output device 1320 may produce an audible alert or notification (e.g., a beep or chime). In some embodiments, the output device 1320 includes one or more haptic devices for producing vibrations, motion, or other haptic feedback. In some embodiments, all, or portions of the output device 1320 may be integrated with the input device 1315. For example, the input device 1315 and output device 1320 may form a touchscreen or similar touch-sensitive display. In other embodiments, the output device 1320 may be located near the input device 1315.

The transceiver 1325 includes at least transmitter 1330 and at least one receiver 1335. The transceiver 1325 may be used to provide UL communication signals to a base unit 121 and to receive DL communication signals from the base unit 121, as described herein. Similarly, the transceiver 1325 may be used to transmit and receive SL signals (e.g., V2X communication), as described herein. Although only one transmitter 1330 and one receiver 1335 are illustrated, the user equipment apparatus 1300 may have any suitable number of transmitters 1330 and receivers 1335. Further, the transmitter(s) 1330 and the receiver(s) 1335 may be any suitable type of transmitters and receivers. In one embodiment, the transceiver 1325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1325, transmitters 1330, and receivers 1335 may be implemented as physically separate components that access a shared hardware resource and/or software resource, such as for example, the network interface 1340.

In various embodiments, one or more transmitters 1330 and/or one or more receivers 1335 may be implemented and/or integrated into a single hardware component, such as a multi-transceiver chip, a system-on-a-chip, an ASIC, or other type of hardware component. In certain embodiments, one or more transmitters 1330 and/or one or more receivers 1335 may be implemented and/or integrated into a multi-chip module. In some embodiments, other components such as the network interface 1340 or other hardware components/circuits may be integrated with any number of transmitters 1330 and/or receivers 1335 into a single chip. In such embodiment, the transmitters 1330 and receivers 1335 may be logically configured as a transceiver 1325 that uses one more common control signals or as modular transmitters 1330 and receivers 1335 implemented in the same hardware chip or in a multi-chip module.

FIG. 14 depicts one embodiment of a network apparatus 1400 that may be used for low-latency NTN-based UE location verification, according to embodiments of the disclosure. In some embodiments, the network apparatus 1400 may be one embodiment of a RAN node and its supporting hardware, such as the base unit 121 and/or gNB, described above. Furthermore, network apparatus 1400 may include a processor 1405, a memory 1410, an input device 1415, an output device 1420, and a transceiver 1425. In certain embodiments, the network apparatus 1400 does not include any input device 1415 and/or output device 1420.

As depicted, the transceiver 1425 includes at least one transmitter 1430 and at least one receiver 1435. Here, the transceiver 1425 communicates with one or more remote units 105. Additionally, the transceiver 1425 may support at least one network interface 1440 and/or application interface 1445. The application interface(s) 1445 may support one or more APIs. The network interface(s) 1440 may support 3GPP reference points, such as Uu, N1, N2, N3, N5, N6 and/or N7 interfaces. Other network interfaces 1440 may be supported, as understood by one of ordinary skill in the art.

The processor 1405, in one embodiment, may include any known controller capable of executing computer-readable instructions and/or capable of performing logical operations. For example, the processor 1405 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1405 executes instructions stored in the memory 1410 to perform the methods and routines described herein. The processor 1405 is communicatively coupled to the memory 1410, the input device 1415, the output device 1420, and the transceiver 1425. In certain embodiments, the processor 1405 may include an application processor (also known as “main processor”) which manages application-domain and operating system (“OS”) functions and a baseband processor (also known as “baseband radio processor”) which manages radio function. In various embodiments, the processor 1405 controls the network apparatus 1400 to implement the above described network entity behaviors (e.g., of the gNB) for low-latency NTN-based UE location verification.

The memory 1410, in one embodiment, is a computer readable storage medium. In some embodiments, the memory 1410 includes volatile computer storage media. For example, the memory 1410 may include a RAM, including dynamic RAM (“DRAM”), synchronous dynamic RAM (“SDRAM”), and/or static RAM (“SRAM”). In some embodiments, the memory 1410 includes non-volatile computer storage media. For example, the memory 1410 may include a hard disk drive, a flash memory, or any other suitable non-volatile computer storage device. In some embodiments, the memory 1410 includes both volatile and non-volatile computer storage media.

In some embodiments, the memory 1410 stores data relating to CSI enhancements for higher frequencies. For example, the memory 1410 may store parameters, configurations, resource assignments, policies, and the like as described above. In certain embodiments, the memory 1410 also stores program code and related data, such as an operating system (“OS”) or other controller algorithms operating on the network apparatus 1400, and one or more software applications.

The input device 1415, in one embodiment, may include any known computer input device including a touch panel, a button, a keyboard, a stylus, a microphone, or the like. In some embodiments, the input device 1415 may be integrated with the output device 1420, for example, as a touchscreen or similar touch-sensitive display. In some embodiments, the input device 1415 includes a touchscreen such that text may be input using a virtual keyboard displayed on the touchscreen and/or by handwriting on the touchscreen. In some embodiments, the input device 1415 includes two or more different devices, such as a keyboard and a touch panel.

The output device 1420, in one embodiment, may include any known electronically controllable display or display device. The output device 1420 may be designed to output visual, audible, and/or haptic signals. In some embodiments, the output device 1420 includes an electronic display capable of outputting visual data to a user. Further, the output device 1420 may be a component of a smart phone, a personal digital assistant, a television, a table computer, a notebook (laptop) computer, a personal computer, a vehicle dashboard, or the like.

In certain embodiments, the output device 1420 includes one or more speakers for producing sound. For example, the output device 1420 may produce an audible alert or notification (e.g., a beep or chime). In some embodiments, the output device 1420 includes one or more haptic devices for producing vibrations, motion, or other haptic feedback. In some embodiments, all, or portions of the output device 1420 may be integrated with the input device 1415. For example, the input device 1415 and output device 1420 may form a touchscreen or similar touch-sensitive display. In other embodiments, all, or portions of the output device 1420 may be located near the input device 1415.

As discussed above, the transceiver 1425 may communicate with one or more remote units and/or with one or more interworking functions that provide access to one or more PLMNs. The transceiver 1425 may also communicate with one or more network functions (e.g., in the mobile core network 80). The transceiver 1425 operates under the control of the processor 1405 to transmit messages, data, and other signals and also to receive messages, data, and other signals. For example, the processor 1405 may selectively activate the transceiver (or portions thereof) at particular times in order to send and receive messages.

The transceiver 1425 may include one or more transmitters 1430 and one or more receivers 1435. In certain embodiments, the one or more transmitters 1430 and/or the one or more receivers 1435 may share transceiver hardware and/or circuitry. For example, the one or more transmitters 1430 and/or the one or more receivers 1435 may share antenna(s), antenna tuner(s), amplifier(s), filter(s), oscillator(s), mixer(s), modulator/demodulator(s), power supply, and the like. In one embodiment, the transceiver 1425 implements multiple logical transceivers using different communication protocols or protocol stacks, while using common physical hardware.

In one embodiment, the processor 1405 transmits, via the transceiver 1425, a low-latency UE location request comprising a location configuration to a second network entity with location server functionality, the location configuration comprising at least a request to provide location information for the UE within a configured time window, receives, via the transceiver 1425, a location information response from the second network entity based on the transmitted location request, and performs a low-latency verification process of the location information for the UE based on the received location response.

In one embodiment, the first network entity comprises an AMF and the second network entity comprises an NG-RAN node equipped with an LMC.

In one embodiment, the processor 1405 transmits, via the transceiver 1425, a UE location verification request to the NG-RAN node.

In one embodiment, the processor 1405 transmits, via the transceiver 1425, a location request configuration to the NG-RAN node, the location request configuration comprising a request for a UE location based on a configured location method type.

In one embodiment, the processor 1405 invokes a location service operation by an LMF, the location service operation comprising a location request based on a single configured location method type.

In one embodiment, the configured location method type consists of RAT-dependent method, a RAT-independent method, or a combination thereof.

In one embodiment, the processor 1405 invokes a location service operation by a LMF, the location service operation comprising multiple location requests corresponding to multiple configured positioning method types.

In one embodiment, the processor 1405 generates a location report based on a low-latency verification process, the location report comprising a plurality of location estimates corresponding to multiple method types.

In one embodiment, the processor 1405, based on the location configuration, transmits, via the transceiver 1425, a first location configuration request to the location server, the first location configuration comprising a first estimate of the location of the UE using a first location method type, transmit a second location configuration request to the location server, the second location configuration comprising a second estimate of the location of the UE using a second location method type, receive a location response from the location server for the first configuration and the second configuration, perform a verification process based on the location response of the first configuration, the second configuration, or a combination thereof, and perform a validation process of a location method type.

In one embodiment, the processor 1405 initiates two location request messages to a LMF for determining location estimates for the UE using a RAT-independent method and RAT-dependent methods in a sequential manner.

In one embodiment, the processor 1405 initiates one location request message a LMF for determining location estimates for the UE using a RAT-independent method and RAT-dependent methods.

In one embodiment, the processor 1405 repeats a location estimate process if a delay between two location estimates exceeds a predefined threshold value.

In one embodiment, the processor 1405 receives, via the transceiver 1425, a low-latency UE location verification request comprising a location configuration from a second network entity, the location configuration comprising at least a request to provide location information for the UE within a configured time window, performs a low-latency verification process of the location information for the UE, and transmits, via the transceiver 1425, a location information response to the second network entity based on the transmitted verification request.

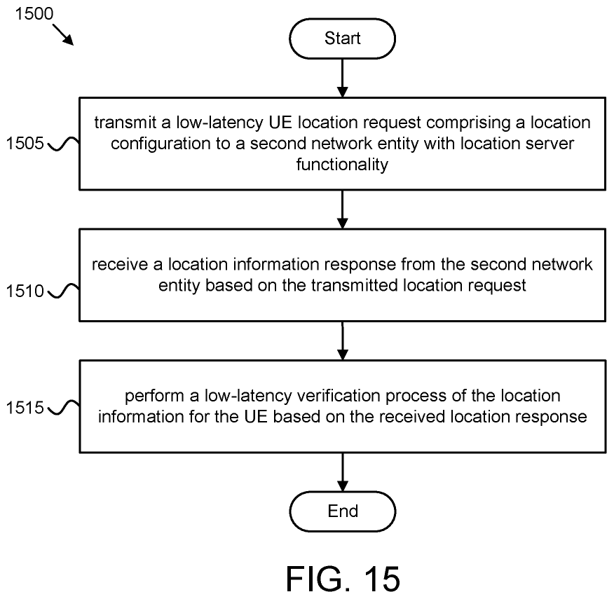

FIG. 15 is a flowchart diagram of a method 1500 for low-latency NTN-based UE location verification. The method 1500 may be performed by a network entity as described herein, for example, the gNB, base station 121, a network function (e.g., an AMF or an LMF), and/or the network equipment apparatus 1400. In some embodiments, the method 1500 may be performed by a processor executing program code, for example, a microcontroller, a microprocessor, a CPU, a GPU, an auxiliary processing unit, a FPGA, or the like.

In one embodiment, the method 1500 begins and transmits 1505 a low-latency UE location request comprising a location configuration to a second network entity with location server functionality. In one embodiment, the method 1500 receives 1510 a location information response from the second network entity based on the transmitted location request. In one embodiment, the method 1500 performs 1515 a low-latency verification process of the location information for the UE based on the received location response, and the method 1500 ends.

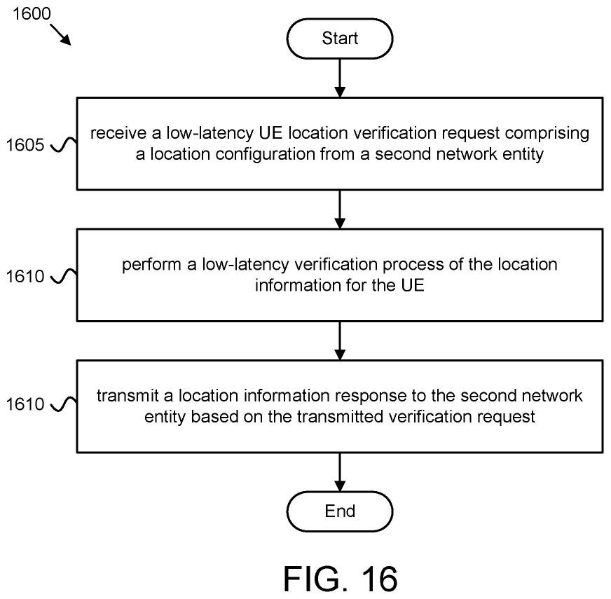

FIG. 16 is a flowchart diagram of a method 1600 for low-latency NTN-based UE location verification. The method 1600 may be performed by a network entity as described herein, for example, the gNB, base station 121, a network function (e.g., an AMF or an LMF), and/or the network equipment apparatus 1400. In some embodiments, the method 1600 may be performed by a processor executing program code, for example, a microcontroller, a microprocessor, a CPU, a GPU, an auxiliary processing unit, a FPGA, or the like.

In one embodiment, the method 1600 begins and receives 1605 a low-latency UE location verification request comprising a location configuration from a second network entity. In one embodiment, the method 1600 performs a low-latency verification process of the location information for the UE. In one embodiment, the method 1600 transmits 1615 a location information response to the second network entity based on the transmitted verification request, and the method 1600 ends.

A first apparatus is disclosed for low-latency NTN-based UE location verification. The first apparatus may include a network entity as described herein, for example, the gNB, base station 121, a network function (e.g., an AMF or an LMF), and/or the network equipment apparatus 1400. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver and a processor coupled to the transceiver. In one embodiment, the processor is configured to cause the apparatus to transmit a low-latency UE location request comprising a location configuration to a second network entity with location server functionality, the location configuration comprising at least a request to provide location information for the UE within a configured time window, receive a location information response from the second network entity based on the transmitted location request, and perform a low-latency verification process of the location information for the UE based on the received location response.

In one embodiment, the first network entity comprises an AMF and the second network entity comprises an NG-RAN node equipped with an LMC.

In one embodiment, the processor is configured to cause the apparatus to transmit a UE location verification request to the NG-RAN node.

In one embodiment, the processor is configured to cause the apparatus to transmit a location request configuration to the NG-RAN node, the location request configuration comprising a request for a UE location based on a configured location method type.

In one embodiment, the processor is configured to cause the apparatus to invoke a location service operation by an LMF, the location service operation comprising a location request based on a single configured location method type.

In one embodiment, the configured location method type consists of RAT-dependent method, a RAT-independent method, or a combination thereof.

In one embodiment, the processor is configured to cause the apparatus to invoke a location service operation by a LMF, the location service operation comprising multiple location requests corresponding to multiple configured positioning method types.

In one embodiment, the processor is configured to cause the apparatus to generate a location report based on a low-latency verification process, the location report comprising a plurality of location estimates corresponding to multiple method types.

In one embodiment, the processor is configured to cause the apparatus to, based on the location configuration, transmit a first location configuration request to the location server, the first location configuration comprising a first estimate of the location of the UE using a first location method type, transmit a second location configuration request to the location server, the second location configuration comprising a second estimate of the location of the UE using a second location method type, receive a location response from the location server for the first configuration and the second configuration, perform a verification process based on the location response of the first configuration, the second configuration, or a combination thereof, and perform a validation process of a location method type.

In one embodiment, the processor is configured to cause the apparatus to initiate two location request messages to a LMF for determining location estimates for the UE using a RAT-independent method and RAT-dependent methods in a sequential manner.

In one embodiment, the processor is configured to cause the apparatus to initiate one location request message a LMF for determining location estimates for the UE using a RAT-independent method and RAT-dependent methods.

In one embodiment, the processor is configured to cause the apparatus to repeat a location estimate process if a delay between two location estimates exceeds a predefined threshold value.

A first method of a first network entity apparatus is disclosed for low-latency NTN-based UE location verification. The first method may be performed by a network entity as described herein, for example, the gNB, base station 121, a network function (e.g., an AMF or an LMF), and/or the network equipment apparatus 1400. In some embodiments, the first method may be performed by a processor executing program code, for example, a microcontroller, a microprocessor, a CPU, a GPU, an auxiliary processing unit, a FPGA, or the like.

In one embodiment, the first method transmits a low-latency UE location request comprising a location configuration to a second network entity with location server functionality, the location configuration comprising at least a request to provide location information for the UE within a configured time window, receives a location information response from the second network entity based on the transmitted location request, and performs a low-latency verification process of the location information for the UE based on the received location response.

In one embodiment, the first network entity comprises an AMF and the second network entity comprises an NG-RAN node equipped with an LMC.

In one embodiment, the first method transmits a UE location verification request to the NG-RAN node.

In one embodiment, the first method transmits a location request configuration to the NG-RAN node, the location request configuration comprising a request for a UE location based on a configured location method type.

In one embodiment, the first method invokes a location service operation by an LMF, the location service operation comprising a location request based on a single configured location method type.

In one embodiment, the configured location method type consists of RAT-dependent method, a RAT-independent method, or a combination thereof.

In one embodiment, the first method invokes a location service operation by a LMF, the location service operation comprising multiple location requests corresponding to multiple configured positioning method types.

In one embodiment, the first method generates a location report based on a low-latency verification process, the location report comprising a plurality of location estimates corresponding to multiple method types.

In one embodiment, the first method, based on the location configuration, transmits a first location configuration request to the location server, the first location configuration comprising a first estimate of the location of the UE using a first location method type, transmits a second location configuration request to the location server, the second location configuration comprising a second estimate of the location of the UE using a second location method type, receives a location response from the location server for the first configuration and the second configuration, performs a verification process based on the location response of the first configuration, the second configuration, or a combination thereof, and performs a validation process of a location method type.

In one embodiment, the first method initiates two location request messages to a LMF for determining location estimates for the UE using a RAT-independent method and RAT-dependent methods in a sequential manner.

In one embodiment, the first method initiates one location request message a LMF for determining location estimates for the UE using a RAT-independent method and RAT-dependent methods.

In one embodiment, the first method repeats a location estimate process if a delay between two location estimates exceeds a predefined threshold value.

A second apparatus is disclosed for low-latency NTN-based UE location verification. The second apparatus may include a network entity as described herein, for example, the gNB, base station 121, a network function (e.g., an AMF or an LMF), and/or the network equipment apparatus 1400. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver and a processor coupled to the transceiver. In one embodiment, the processor is configured to cause the apparatus to receive a low-latency UE location verification request comprising a location configuration from a second network entity, the location configuration comprising at least a request to provide location information for the UE within a configured time window, perform a low-latency verification process of the location information for the UE, and transmit a location information response to the second network entity based on the transmitted verification request.

A second method is disclosed for low-latency NTN-based UE location verification. The second method may be performed by a network entity as described herein, for example, the gNB, base station 121, a network function (e.g., an AMF or an LMF), and/or the network equipment apparatus 1400. In some embodiments, the second method may be performed by a processor executing program code, for example, a microcontroller, a microprocessor, a CPU, a GPU, an auxiliary processing unit, a FPGA, or the like.

In one embodiment, the second method receives a low-latency UE location verification request comprising a location configuration from a second network entity, the location configuration comprising at least a request to provide location information for the UE within a configured time window, performs a low-latency verification process of the location information for the UE, and transmits a location information response to the second network entity based on the transmitted verification request.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network entity, comprising:
at least one memory; and
at least one processor coupled to the at least one memory and configured to cause the network entity to:
transmit a user equipment (“UE”) location request comprising a location configuration to a second network entity with location server functionality, the location configuration comprising a type of method to be used for location determination and an indication that location estimates for the UE are for verification;
receive a location information response from the second network entity based on the UE location request, wherein the location information response comprises location estimates for the UE; and
perform a verification process of the location estimates for the UE based on the received location information response.

2. The network entity of claim 1, wherein the network entity comprises an access and mobility management function (“AMF”) and the second network entity comprises a new generation radio access network (“NG-RAN”) node equipped with a location management component (“LMC”).

3. The network entity of claim 2, wherein the at least one processor is configured to cause the network entity to transmit a UE location verification request to the NG-RAN node.

4. The network entity of claim 2, wherein the at least one processor is configured to cause the network entity to transmit a location request configuration to the NG-RAN node, the location request configuration comprising a request for a UE location based on a configured location method type.

5. The network entity of claim 1, wherein the at least one processor is configured to cause the network entity to invoke a location service operation by a location management function (“LMF”), the location service operation comprising a location request based on a single configured location method type.

6. The network entity of claim 4, wherein the configured location method type consists of radio access technology (“RAT”)-dependent method, a RAT-independent method, or a combination thereof.

7. The network entity of claim 1, wherein the at least one processor is configured to cause the network entity to invoke a location service operation by a location management function (“LMF”), the location service operation comprising multiple location requests corresponding to multiple configured positioning method types.

8. The network entity of claim 1, wherein the at least one processor is configured to cause the network entity to generate a location report based on the verification process, the location report comprising a plurality of location estimates corresponding to multiple method types.

9. The network entity of claim 1, wherein the at least one processor is configured to cause the network entity to, based on the location configuration:
transmit a request for a first location configuration to a location server, the first location configuration comprising a first estimate of a location of the UE using a first location method type;
transmit a request for a second location configuration to the location server, the second location configuration comprising a second estimate of the location of the UE using a second location method type;
receive a location response from the location server for the first location configuration and the second location configuration;
perform a verification process based on the location response of the first location configuration, the second location configuration, or a combination thereof; and
perform a validation process of a location method type.

10. The network entity of claim 9, wherein the at least one processor is configured to cause the network entity to initiate two location request messages to a location management function (“LMF”) for determining location estimates for the UE using a radio access technology (“RAT”)-independent method and RAT-dependent methods in a sequential manner.

11. The network entity of claim 9, wherein the at least one processor is configured to cause the network entity to initiate one location request message a location management function (“LMF”) for determining location estimates for the UE using a radio access technology (“RAT”)-independent method and RAT-dependent methods.

12. The network entity of claim 1, wherein the at least one processor is configured to cause the network entity to repeat a location estimate process if a delay between two location estimates exceeds a predefined threshold value.

13. A method performed by a network entity, comprising:
transmitting a user equipment (“UE”) location request comprising a location configuration to a second network entity with location server functionality, the location configuration comprising a type of method to be used for location determination and an indication that location estimates for the UE are for verification;
receiving a location information response from the second network entity based on the UE location request, wherein the location information response comprises location estimates for the UE; and
performing a verification process of the location estimates for the UE based on the received location information response.

14. The method of claim 13, wherein the first network entity comprises an access and mobility management function (“AMF”) and the second network entity comprises a new generation radio access network (“NG-RAN”) node equipped with a location management component (“LMC”).

15. A network entity, comprising:
at least one memory; and
at least one processor coupled to the at least one memory and configured to cause the network entity to:
receive a user equipment (“UE”) location request comprising a location configuration to a second network entity with location server functionality, the location configuration comprising a type of method to be used for location determination and an indication that location estimates for the UE are for verification;
perform a verification process of the location information estimates for the UE; and
transmit a location information response to the second network entity, the location information response comprising the location estimates for the UE.

16. A processor for wireless communication, comprising:
at least one controller coupled with at least one memory and configured to cause the processor to:
transmit a user equipment (“UE”) location request comprising a location configuration to a network entity with location server functionality, the location configuration comprising a type of method to be used for location determination and an indication that location estimates for the UE are for verification;
receive a location information response from the second network entity based on the UE location request, wherein the location information response comprises location estimates for the UE; and
perform a verification process of the location estimates for the UE based on the received location information response.

17. The processor of claim 16, wherein the processor comprises an access and mobility management function (“AMF”) and the network entity comprises a new generation radio access network (“NG-RAN”) node equipped with a location management component (“LMC”).

18. The processor of claim 17, wherein the at least one controller is configured to cause the processor to transmit a UE location verification request to the NG-RAN node.

19. The processor of claim 17, wherein the at least one controller is configured to cause the processor to transmit a location request configuration to the NG-RAN node, the location request configuration comprising a request for a UE location based on a configured location method type.

20. The processor of claim 16, wherein the at least one controller is configured to cause the processor to invoke a location service operation by a location management function (“LMF”), the location service operation comprising a location request based on a single configured location method type.
